(19) United States
(12) Patent Application Publication
(10) Pub. No.: US 2020/0391992 A1
(43) Pub. Date: Dec. 17, 2020

(54) DEVICES AND METHODS FOR FLUID METERING

(71) Applicant: ENVIROFIT INTERNATIONAL, INC., Fort Collins, CO (US)

(72) Inventors: Ron Bills, Castle Rock, CO (US); Nathan Lorenz, Laporte, CO (US); Tim Bauer, Fort Collins, CO (US); Jesse Walker, Fort Collins, CO (US); Marcus Newsom, Fort Collins, CO (US)

(21) Appl. No.: 16/493,706

(22) PCT Filed: Mar. 13, 2018
(86) PCT No.: PCT/US2018/022142

§ 371 Date: Sep. 12, 2019

Related U.S. Application Data
(60) Provisional application No. 62/470,763, filed on Mar. 13, 2017.

(51) Int. Cl. B67D 7/34; B67D 7/14; B67D 7/16; F17C 7/02; G06Q 20/14; G07F 15/00

(52) U.S. Cl. CPC B67D 7/34; F17C 2270/0745; B67D 7/16; F17C 7/02; G06Q 20/145; G07F 15/001; F17C 2201/0109; F17C 2205/0326; F17C 2205/0338; F17C 2205/0394; F17C 2205/054; F17C 2221/033; F17C 2221/035; F17C 2223/0153; F17C 2223/035; F17C 2250/034; F17C 2250/043; F17C 2250/0439; F17C 2250/0443; F17C 2250/0495; F17C 2260/024; F17C 2265/04; B67D 7/145

(57) ABSTRACT

Disclosed herein are devices, methods, and systems that useful for allowing consumers to purchase a fluid in limited and/or discrete amounts or volumes, for example as-needed, daily, weekly, etc. In various embodiments, the disclosed devices, systems, and methods provide for an innovative fluid distribution system, including a device that can receive and monitor payment for a discrete amount of fluid, measure the fluid as it flows through the device, and stop fluid flow when the discrete amount of fluid has flowed through the device. The disclosed device may be in communication with a central server for receiving payment from the user, and providing information to the central server of the device's status.

### CROSS REFERENCE TO RELATED APPLICATIONS

This application claims PCT priority to U.S. Provisional Patent Application No. 62/470,763 filed on Mar. 13, 2017 and entitled “Devices and Methods for LPG Metering,” and which is incorporated herein in its entirety.

### BACKGROUND

The disclosed devices, processes, methods, and systems are directed to devices, methods, and systems for metering and dispensing a predetermined amount of fluid from a fluid supply.

### SUMMARY

Disclosed herein are devices comprising a housing with a security feature, a metering assembly configured to measure a quantity of fluid distributed from a fluid supply, a device outlet configured to fluidly couple the metering assembly to an apparatus, a locking assembly configured to be coupled to the fluid supply, a controller electrically coupling the housing, metering assembly, and locking assembly. In some embodiments, the device may further include a receiver electrically coupled to the controller, a regulator assembly fluidly coupled to the metering assembly, wherein the regulator assembly is configured to be fluidly coupled to the fluid supply and regulate a flow of a fluid distributed from the fluid supply. The device may further include a valve assembly fluidly coupled to the metering assembly, wherein the valve assembly is configured to control a flow of the fluid through the device, and is configured to be positioned in a valve open position responsive to a first signal, and in a valve closed position responsive to a second signal that is based upon a determination that a predetermined quantity of fluid has been distributed from the fluid supply. The valve assembly may also be configured to be positioned in the valve closed position responsive to a third signal that is based upon a status of a security feature of the housing. In various embodiments, the security feature is an optical sensor, an accelerometer, a motion detector, a barometer, a GPS module, or combinations thereof. In an embodiment, in a first position, the locking assembly is configured to securedly couple the device to the fluid supply and prevent impermissible decoupling of the device from the fluid supply, in a second position, the locking assembly is configured to allow the device to be permissively decoupled from the fluid supply; and the position of the locking assembly is remotely controlled. In an embodiment, the housing further includes a first section and a second section, wherein the first section includes an electronic display, a unit identifier, and a diagnostic interface configured to allow a data stream from the processor of the device to be electrically communicated to an external source, and the second section includes the security feature, and in further embodiments, the electronic display may be configured to default to showing a first set of data to a consumer and is configured to show a second set of data when an authentication code or procedure is entered by an authorized person. In some embodiments, the device further comprises a power source selected from one or more of a battery, a power adaptor for connecting to an external power source, or a photovoltaic cell that provides electrical power to the device. In an embodiment, the housing may include a diagnostic interface configured to charge a battery of the device when an external source is electrically connected to the device through the diagnostic interface, a power adaptor for connecting to an external power source, or a photovoltaic cell that provides electrical power to the device In an embodiment, the metering assembly includes a fluidic oscillator. In an embodiment, the valve assembly may include a plunger assembly coupled to a first motor, and the first motor may be configured to control a position of a plunger of the plunger assembly to move between the open position and the closed position. In an embodiment, the locking assembly further includes a locking shaft coupled to a second motor, wherein the operation of the second motor moves the locking shaft in a linear motion between the second position to the first position. In an embodiment, the locking shaft may interact with a regulator key shaft of the regulator assembly. In some embodiments, the device may further include a predetermined quantity of fluid distributed from the fluid supply based upon a cost of a volumetric unit of the fluid, or upon a cost of mass unit of the fluid.

Also disclosed are methods of distributing a fluid comprising, signaling a fluid metering device that an authorized payment has been received for a predetermined amount of fluid to be transferred through the device; signaling a valve assembly in the device to open a fluid channel; monitoring, by a metering device, an amount of fluid flowing through the device; signaling the valve assembly to close when the predetermined amount of fluid has passed through the metering device; and thereby distributing a fluid. In an embodiment, the method further includes securing the device to a fluid supply to prevent unauthorized decoupling of the device from the fluid supply. In an embodiment, the method further includes receiving payment from a user for the predetermined amount of the fluid. In an embodiment, the method further includes one or more sensors for monitoring light, movement, temperature, barometric pressure. In an embodiment, the method further includes signaling the valve assembly to close in response to a signal generated by a security feature. In an embodiment, the method further includes the security feature is monitoring the device's location via GPS module and/or monitoring light within the device. In an embodiment, the method further includes the security feature generating a signal to the processing unit resulting in a signal being sent to a central server.

Also disclosed is a remotely activated valve for dispensing a predetermined amount of liquid petroleum gas comprising a valve; a controller connected to the valve; and a metering device connected to the controller. In an embodiment, the valve further includes a secondary gas tank, a gas flow meter, and a plurality of sensors. In an embodiment, the metering device is a fluidic oscillator.

Also disclosed are methods for remotely activating a valve for dispensing a predetermined amount of liquid petroleum gas from a tank includes a user sending a request for dispensing a volume of gas from the tank; a provider receiving a request for payment for the volume of gas; the user sending the payment to the provider; the provider authorizing a controller connected to the valve to dispense the gas; the valve dispensing the gas; and a metering device for measuring the dispensed gas. In an embodiment, the security feature may be selected from one or more of an accelerometer, a strain gauge, or a location monitoring device.

Also disclosed are devices that may include a housing with a security feature; a metering assembly configured to measure a quantity of fluid distributed from a fluid supply, a valve assembly fluidly coupled with the metering assembly, wherein the valve assembly is configured to control a flow of the fluid through the device; a device outlet configured to fluidly couple the metering assembly and the valve assembly to an apparatus; a locking assembly configured to be coupled to the fluid supply, a controller electrically coupling the housing, metering assembly, and the locking assembly. In an embodiment, the valve assembly is positioned fluidly upstream of the metering assembly and includes a regulator assembly fluidly coupled to and downstream of the metering assembly, wherein the regulator assembly configured to be fluidly coupled to a fluid supply and regulate a flow of a fluid distributed from the fluid supply. In an embodiment, the device further includes a regulator assembly fluidly coupled to and downstream of the valve assembly, wherein the regulator assembly configured to be fluidly coupled to a fluid supply and regulate a flow of a fluid distributed from the fluid supply. In an embodiment, the valve assembly is positioned fluidly downstream of the metering assembly, and further includes a regulator assembly fluidly coupled to and upstream of the metering assembly, wherein the regulator assembly configured to be fluidly coupled to a fluid supply and regulate a flow of a fluid distributed from the fluid supply. In an embodiment, the device further includes a regulator assembly fluidly coupled to and downstream of the valve assembly, wherein the regulator assembly configured to be fluidly coupled to a fluid supply and regulate a flow of a fluid distributed from the fluid supply. In an embodiment, the fluid may be selected from one or more of liquefied petroleum gas (LPG), liquefied natural gas (LNG), water, purified water, compressed natural gas (CNG), gasoline, diesel, kerosene, cooking oil. In an embodiment, the apparatus may be selected from one or more of a cook stove, a refrigerator, a clothes dryer, a heater, a barbeque, a water heater, an oven, an engine, a generator, a storage vessel. In an embodiment, a position of the locking assembly is remotely controlled.

While multiple embodiments are disclosed, still other embodiments of the present disclosure will become apparent to those skilled in the art from the following detailed description. As will be apparent, the disclosed embodiments are capable of modifications in various obvious aspects, all without departing from the spirit and scope of the present disclosure. Accordingly, the detailed description is to be regarded as illustrative in nature and not restrictive.

### BRIEF DESCRIPTION OF THE DRAWINGS

FIG. 1 is a flowchart illustrating the fluid connections between components of a system.

FIG. 2 is an isometric view of a device and a fluid supply.

FIG. 3 is a rear isometric view of the device of FIG. 1 with a lid removed.

FIG. 4 is an isometric view of the device of FIG. 1 with the housing removed.

FIG. 5 is an isometric view of a regulator assembly.

FIG. 6 is an exploded view of the regulator assembly of FIG. 5.

FIG. 7 is an isometric view of a regulator key shaft.

FIG. 8 is an isometric cross-sectional view along line 8-8 of the regulator key shaft of FIG. 7.

FIG. 9 is a rear isometric view of a locking assembly.

FIG. 10 is a front isometric view of the locking assembly of FIG. 9 with a motor housing, mount plate, and gear housing removed.

FIG. 11 is an isometric view of a locking assembly and a regulator assembly, with the locking assembly positioned in an unlocked position and the regulator key shaft positioned in a first position.

FIG. 12 is an isometric view of the locking assembly and regulator assembly, with the locking assembly positioned in an unlocked position and the regulator key shaft positioned in a second position.

FIG. 13 is an isometric view of the locking assembly and regulator assembly, with the locking assembly positioned in an unlocked position and the regulator key shaft positioned in a third position.

FIG. 14 is an isometric view of the locking assembly and regulator assembly, with the locking assembly positioned in a locked position and the regulator key shaft positioned in a second position.

FIG. 15 is an isometric view of the locking assembly and regulator assembly, with the locking assembly positioned in a locked position and the regulator key shaft positioned in a third position.

FIG. 16 is an isometric view of a metering assembly and a valve assembly.

FIG. 17 is an exploded view of the metering assembly and valve assembly of FIG. 16.

FIG. 18 is an isometric view of the metering assembly and valve assembly of FIG. 16, with the upper housing, lower housing, and valve assembly removed.

FIG. 19 is an isometric cross-sectional view along line 19-19 of the metering assembly and valve assembly of FIG. 18.

FIG. 20 are front views of various metering plates.

FIG. 21 is a cross-sectional view along line 21-21 of the metering assembly and valve assembly of FIG. 16.

FIG. 22 is a cross-sectional view along line 22-22 of the metering assembly and valve assembly of FIG. 16.

FIG. 23 is a cross-sectional view along line 23-23 of the metering assembly and valve assembly of FIG. 16.

FIG. 24 is a flowchart illustrating a method of fluid distribution, in accordance with an embodiment of the present disclosure.

FIG. 25 depicts various embodiments of the disclosed gas metering system, methods, and devices.

FIG. 26 depicts a metering system and device that includes measuring a discrete volume of gas.

FIG. 27 is a schematic of an alternate embodiment of system including a metering device.

FIG. 28 is a schematic of an alternate embodiment of system including a metering device.

FIG. 29 is a schematic of an alternate embodiment of system including a metering device.

FIG. 30 is a schematic of an alternate embodiment of system including a metering device.

FIG. 31 is a schematic of an alternate embodiment of system including a metering device.

FIGS. 32 and 33 are alternative views of some of the embodiments depicted in FIGS. 27-31.

FIG. 34 is a decision chart for a fluid flow through a device.

FIG. 35 is a schematic of various fluid flow paths between a fluid supply and a consumer appliance.

### DETAILED DESCRIPTION

Consumers of various fluids, such as water, purified water, liquefied petroleum gas (LPG), compressed natural gas (CNG), liquefied natural gas (LNG), gasoline, diesel, kerosene, cooking oil, and the like may have a need to purchase a small quantity of the fluid—smaller than may typically be obtained from a typical supplier or distributor and/or than that avail in a typical container. For example, a distributor or supplier may supply a 15 gallon tank of fluid, but a consumer may not have the ability or desire to rent or purchase the entire tank of fluid, and/or the tank itself, even if supplied in smaller quantities.

Disclosed herein are devices, methods, and systems that may aid in reducing the costs (e.g. financial, temporal, spatial, etc.) that may be associated with supplying and using the fluid. In many embodiments, the disclosed devices, methods and systems allow for consumers to purchase the fluid in limited and/or discrete amounts or volumes, for example as-needed, daily, weekly, etc. For example, in embodiments where the fluid is a fuel, consumers in emerging and developing markets may prefer or desire the use of LPG for their cooking needs over the use of biomass, but may select biomass (such as charcoal), because it can be readily obtained in small, affordable quantities. In some cases, liquid or gaseous fuel may be cleaner and/or more convenient than biomass, but must be bought in large quantities and/or require specialized (expensive) equipment such as storage tanks. In addition, cooking with a gas may be more efficient, cost effective, safer, and/or healthier than cooking with biomass. Several factors that have limited adoption by consumers of LPG over biomass include; limited distribution points, upfront/fixed costs of using LPG, familiarity with the use of gas, among others.

In order to help address these barriers, disclosed herein are devices, systems, and methods for an innovative distribution system, including payment, measurement, and dispensing of a consumer fluid (e.g. gas or liquid). In some embodiments, the disclosed devices, methods, and/or systems include an intelligent or smart metering device mounted to a storage tank filled with the fluid that may dispense pre-determined amounts of fluid from the storage tank to an appliance (for example a gas stove). In most embodiments, the metering device is able to accurately, precisely, and efficiently measure and regulate (meter) the amount of the fluid released from the storage tank and/or provided to the appliance. Thus, consumers may use the disclosed devices, methods, and systems to purchase an amount of fluid, less than the total amount in the storage tank, and match the expense or volume of their fluid to the volume needed over a given timespan. This will allow consumers to avoid, or minimize the need to pay for the entire contents of the storage tank at one time. Purchase volumes or amounts may vary depending on the fluid dispensed from the storage tank and the application of its use. In some embodiments, such as wherein the fluid is a fuel, the purchase volume or amount may be selected to allow the consumer to operate a fluid-powered appliance for minutes, hours, or days, or for preparing one meal, two meals, or more. For example, where the appliance is a cook stove, the consumer, as is often the case with biomass, can purchase an amount or volume of fuel sufficient to operate the stove for one day's worth of meals.

In some embodiments, the device is a cylinder mounted cooking gas dispenser with integrated fuel flow meter, remote shutoff valve and communications system which allows users to pay for cooking gas as needed or required. In some embodiments, the disclosed device may allow the consumer to avoid purchasing a tank of gas, or even the tank itself. The disclosed device may precisely measure the flow of a fluid or gas as it is consumed, a communications system may allow users to purchase credits for the device via phone, computer, laptop etc. Credits may be in the form of a measurable amount, or volume of gas, and the device may shuts off gas flow from the device and to the consumer's appliance when the credit is consumed. Additionally, the device contains a fuel pressure regulator, various safety and security features, and a user interface for monitoring the device. The user interface by include both visual and audio feed back allowing users to track their credit usage and cylinder gas level, and in some embodiments manually enter additional credits. Control of the device may be achieved via a telecommunications link, such as a GSM, from a processing unit in the device to a central server that may help track the device's location, monitor and dispense customer credit from a consumer account, monitor fill level of the storage tank or cylinder, monitor internal battery level, and other associated data.

In some embodiments, the device may include a standard fluid regulator, a motor actuated fuel shutoff valve, a fluid flow meter, and controller board. The controller board may include a motor driver, display, buzzer, button, temperature sensor, barometric sensor, GSM module, GPS module, USB Port, and other input/output capabilities. The device may be connected to a fluid storage tank and locked to prevent its unauthorized removal. In many embodiments, remotely or locally controlled motor driven latch may be used to help lock the device to the storage tank. In some embodiments, the locking motor can be activated remotely, via the communications module, or by a technician or service representative when installing the device. Unauthorized removal or tampering may trigger sensors to signal a system lockdown. In some embodiments, this unauthorized activity may also trigger a message to be sent back to a supplier, distributor, or management service alerting them that possible tampering has taken place.

When the user has entered credit into the device or the user's account, the device will signal the fuel shutoff valve (for example, the valve assembly) to open, allowing cooking gas to flow. As fuel flows from the storage tank through the device, the volumetric consumption rate is tracked and converted into a mass flow rate with known cylinder or storage tank parameters (i.e. volume, initial composition of the fluid) and environmental calibration factors (e.g. temperature and atmospheric pressure) as well as unit specific flow calibration that is calibrated at the factory and input into the device before the device ships to the market. In some embodiments, the metering assembly may be tested, analyzed, and calibrated at one location, with known temperature and pressures, and the calibration values may be entered into a processing unit matched with the specific metering assembly.

When user credit falls below a pre-determined threshold, the user may be alerted, messaged, or notified to purchase additional credit, for example via mobile money or other payment system to avoid running out of fuel. When addition credit is purchased and entered into the user's account, and device may be updated, to reflect the additional credits, within seconds of credit updates. When the device calculates that the amount of fluid remaining in the cylinder or storage tank has reached a predetermined amount, the device may generate a signal or message the central server to send a request for a technician to be dispatched or scheduled to be dispatched with a replacement cylinder or storage tank. Power sources, such as batteries, may also be replaced based on signals sent by the device to the central server. In an embodiment, the power source may be replaced or recharged, as required, during cylinder changes.

The device may include a user interface for displaying various information. In some embodiments, the display is in graphic form and may provide, for example, the amount of gas remaining in the storage tank, the amount of credit in gas volume, current credit value, fuel flow, battery level, etc. In some embodiments the customer can connect their mobile phone to the device via Bluetooth communications and view this same data. In some embodiments, the device can be partially or substantially completely controlled from the central server. In many embodiments, the disclosed device may enter various “safe” modes, such as where the device is locked and no gas is allowed to flow from the device in response to a possible tampering event, a leak (fuel flow when fuel valve is closed), or if communication with the central server is prevented.

Devices for use with the disclosed methods and systems may include a housing, a regulator assembly, a metering assembly, a valve assembly, a locking assembly, and a controller or processing unit. The processing unit or controller may be in electronic communication with one or more of sensors, actuators, motors, input/output devices in or on the housing, metering assembly, valve assembly, and the locking assembly. In an embodiment, the device may also include a consumer appliance interface that may be used to fluidly couple the valve assembly to a consumer appliance that utilizes the fluid supplied. Such appliances include a cook stove, heater, refrigerator, electric generator, water dispenser, etc.

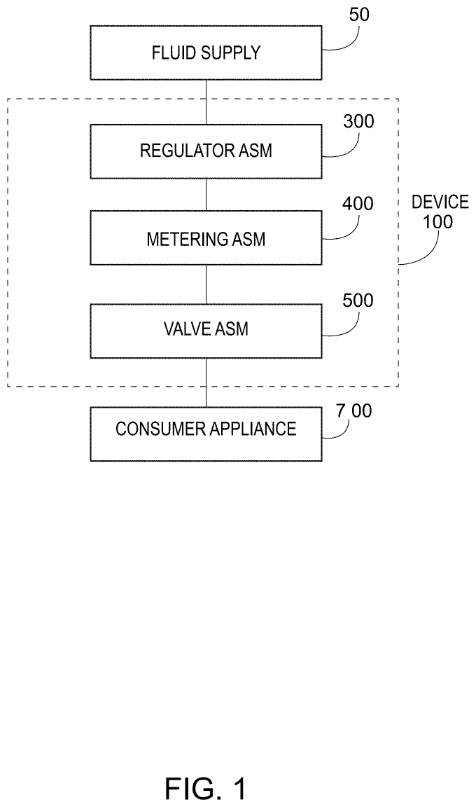

FIG. 1 is a flowchart illustrating the fluid connections between components of the claimed device and system that may be used to meter and distribute a fluid from a fluid supply 50 to a consumer appliance 700. In some embodiments, the system may include a fluid supply 50 that is fluidly connected to a device having a regulator assembly 300. The regulator assembly 300 may be used to regulate the flow of fluid from the fluid supply into the regulator assembly 300 and ultimately to the consumer appliance 700. The regulator assembly 300 may be fluidly connected to a metering assembly 400 within the device. The metering assembly 400 may measure the amount of fluid flowing through the metering assembly 300 as the fluid flows from the fluid supply 50 to the consumer appliance 700. The metering assembly 400 may be fluidly connected to a valve assembly 500 within the device. The valve assembly 500 may be fluidly connected to the consumer appliance 700. The valve assembly 500 may be used to control the fluid connection to the consumer appliance 700. In some examples, if the valve assembly 500 is positioned in a closed position, the consumer appliance 700 is not fluidly connected to the fluid supply 50. In some embodiments, if the valve assembly 500 is positioned in an open position, the consumer appliance 700 is fluidly connected to the fluid supply 50 such that fluid from the fluid supply 50 travels through the regulator assembly 300, the metering assembly 400, and the valve assembly 500 to ultimately be delivered to the consumer appliance 700.

In some embodiments, a device 100 may include the metering assembly 400, the valve assembly 500, and, optionally, the regulator assembly 300. Other components may also be included with the device as discussed below.

FIG. 35 is a schematic of various fluid flow paths through the disclosed device and between a fluid supply and a consumer appliance. In some embodiments, the device may include the metering assembly and valve assembly. In these devices, the fluid flow path will flow from the fluid supply, through the metering assembly, through the valve assembly and to the appliance, or the fluid may flow through the valve assembly, the metering assembly, and into the consumer appliance. In some embodiments, a regulator assembly may be optionally upstream or downstream of the metering assembly the and valve assembly, or the valve assembly and the metering assembly.

In some embodiments, the regulator may be supplied by the consumer. In some embodiments, the metering assembly is fluidly connected to the fluid supply, and the valve assembly may be fluidly connected and downstream of the metering assembly. In some embodiments, the valve assembly is fluidly connected to the fluid supply, and the metering assembly is downstream and fluidly connected to the valve assembly. In some embodiments, the fluid supply may be fluidly connected to the valve assembly, which is fluidly connected to the metering assembly downstream of the valve assembly, which is fluidly connected to the regulator assembly downstream of the metering assembly, such that fluid from the fluid supply may flow through the valve assembly, then through the metering assembly, and then through the regulator assembly.

### Components

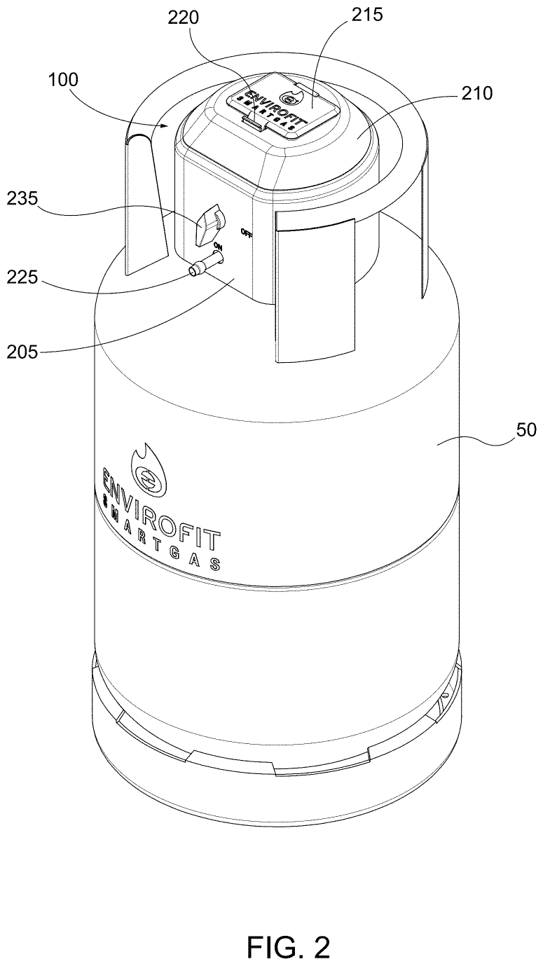

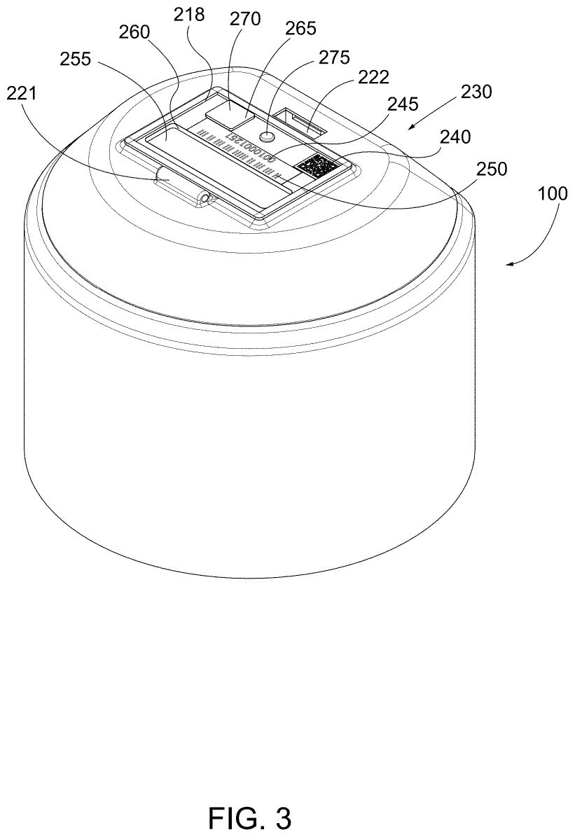

FIGS. 2-3 show various views of an embodiment of a device in accordance with the present disclosure. FIG. 2 is an exterior isometric view of a device 100 coupled to a fluid supply 50. The device 100 includes a housing 200 having a lower enclosure 205, a top cover 210, a lid 215, a latch 220, a hinge 221, a user interface 230, and an engagement feature 235. FIG. 3 is a rear isometric view of the device 100 of FIG. 2 with the lid 215 removed. Also visible in FIG. 3 is a lid seal 218, a hinge 221, a latch box 222, a user interface 230, a unit identifier 240, 245, 250, an electronic screen 255, a screen cover 260, a diagnostic port 265, a diagnostic port cover 270, and an input member 275.

### Housing 200

In some embodiments, the device 100 may include the housing 200 with the lower enclosure 205, the top cover 210, and the lid 215. The lower enclosure 205 may define a bottom portion and a side portion of the device 100. The top cover 210 may mate with the lower enclosure 205 to substantially form a protective barrier around internal components (not shown in FIGS. 2 and 3) of the device 100. The housing 200 may help to prevent damage to the internal components of the device 100. Damage may result from environmental elements, such as wind, rain, sun, debris, etc., or from consumer interactions, such as accidental impacts, or unauthorized removal or displacement of the device 100. The housing 200 may also help prevent modification or disassembly of the device 100, for example disassembly to circumvent or disable certain features of the device 100. Located at a side of the housing 200, may be an engagement feature 235.

The lid 215 may be adjustably coupled to the top cover 210. In some embodiments, the hinge 221 may be formed in the top cover 210 to engage with a portion of the lid 215. In many embodiments, the hinge 221 may be configured so that the lid 215 may be rotated with respect to the cover 210, allowing the lid to be positioned in an open and alternately closed position. In some embodiments, the lid 215 has the latch 220 that may interface with a latch box 222 formed in the top cover 210. The latch 220 may allow the lid 215 to be secured in the closed position, such as that shown in FIG. 2, to prevent or decrease potential damage to components positioned under the lid 215. The lid seal 218 may be used to further protect against damage to internal components positioned within or near the top cover 210.

In some embodiments, the lid 215 may be coupled with the top cover 210 using another form of an adjustable closure mechanism, such as a sliding engagement, a snap fit, a hook and loop fastener assembly, a barbed prong, etc.

The engagement feature 235, depicted in FIG. 2, may define a handle or knob that may aid a service representative, distributor, or technician to securedly attach the device 100 to the fluid supply 50. In some embodiments, the fluid supply 50 may be in the form of a storage tank. In many embodiments, the engagement feature 235 may also be used to control fluid flow from the storage tank to the device. In many embodiments, the fluid may flow first to a regulator assembly (described below).

The housing 200 may also include markings to help a consumer or technician identify the device and/or help position the engagement feature 235 with respect to the housing 200. The markings may further help to inform the technician or consumer as to an operating status of the device 100. For example, in some embodiments, the markings may include “ON” or “OFF” or a similar translated equivalent of these words that may reflect the status of fluid flow from the storage tank to the device. As describe below, “ON” does not mean that fluid will flow to the appliance. For example, if the device has determined that the user has no credit, even if the engagement device points to “ON,” fluid will not flow to the device.

The device 100 may also include the user interface 230. In some embodiments, the user interface 230 includes multiple unit identifiers 240, 245, 250, the electronic screen 255, the electronic screen cover 260, the diagnostic port 265, the diagnostic port cover 270, and the input member 275. One or more parts of the user interface 230 may be in electronic communication with one or more power sources or supplies, data storage devices, controllers, controller boards, drivers, processing units, input/output devices, communications devices, temperature sensors, pressure sensors, accelerometers, barometric pressure sensors, communications modules, GSM module, GPS modules, etc.

In some embodiments .the user interface 230 may provide a consumer with audio and visual feedback about the device 100. In some embodiments, the device may include at least one device unit identifier. In some embodiments, multiple unit identifiers 240, 245, 250 may include features such as an alphanumeric serial number, a model number, a QR code, a bar code, and similar identification types, or various combinations thereof. The unit identifiers 240, 245, 250 may be used to help the consumer, or a supplier, technician, or distributor, identify a make, model, or manufacture date of the device 100. This information may be useful for providing support, use instructions, and/or to troubleshoot or fix functional, diagnostic, or issues, etc. The unit identifiers 240, 245, 250 may also be used to help a consumer identify the model and type of device 100 to learn about various features and operational protocols for that unit.

In some embodiments, the input member 275 may be one or more buttons, knobs, or dials electronically connected to other components of the device 100. In some embodiments, the input member 275 may include the capacity to provide an audio feedback component, such as a tone, buzzer, chime, or other audible signal or alert. In some embodiments, the input member 275 may be in electronic communication, without limitation, to a combination of one or more power sources, power units, data storage devices, controllers, control boards, drivers, actuators, input devices, output devices, displays, and/or processing components. In some embodiments, the power source may be one or more of a battery and/or photovoltaic cell. In some embodiments, the power source may be located outside of the housing such that the device may be electrically connected to an external power source, such as a power grid that may be in a house, business, building, neighborhood, city, etc. This may also be referred to as connected to wall power. In some embodiments, the device may include a power converter that may allow the device to connect to a variety of power sources of differing currents, amperages, and voltages. In some embodiments, the device may include one or more devices that may protect electronic equipment within the device from current surges or drops, voltage surges or drops, and/or temporary power outages.

A consumer, technician, or authorized personnel may engage the input member 275 to access information about, or to change parameters of, or to program or reprogram the device 100. In some embodiments, information may be displayed on the screen 255 or may be displayed on an attached diagnostic device in electronic communication with the input member 275. The attached diagnostic device may be permanently or removeably connected by one or more communications conduits (i.e. “hard wired”) to the device 100 or the diagnostic device may be connected to the device 100 wirelessly (for example via Bluetooth, Wi-Fi, ZigBee, Z-wave, cellular network, 2G, 3G, 4G, infrared, LAN, WLAN, GSM, GAN, wireless PAN, wireless LAN, MANET, WiMAX, wireless WAN, wireless MAN, or other method.) In some embodiments, the diagnostic device may be a smartphone, tablet, monitor or other input and/or output device configured to interface electronically with the device. In some embodiments, a removable data storage device (e.g. sim card, thumb drive, flash drive, etc.) is included with the device 100, and the diagnostic device may read data from the removable data storage device.

The type of information that may be electronically communicated to and displayed on the screen 255 may include a variety of consumer or non-consumer information. For example the screen may display consumer account information, account credit level, battery status or power level, sensor information regarding the current environmental conditions (e.g. temperature, barometric pressure), information as to the amount of fluid in an attached fluid supply, cylinder, or storage tank, or the current rate of flow of fluid through the device 100. In other embodiments, the ratio of the amount of fluid that has been distributed from the fluid supply compared to the amount approved for distribution or release from the fluid supply 50 is displayed, or the performance history or status of features of the device 100 such as the function of the regulator, metering assembly, locking assembly, valve assembly, battery, and security features may be displayed. The information may be displayed in graphic or text form. The screen 255 may be protected by the screen cover 260.

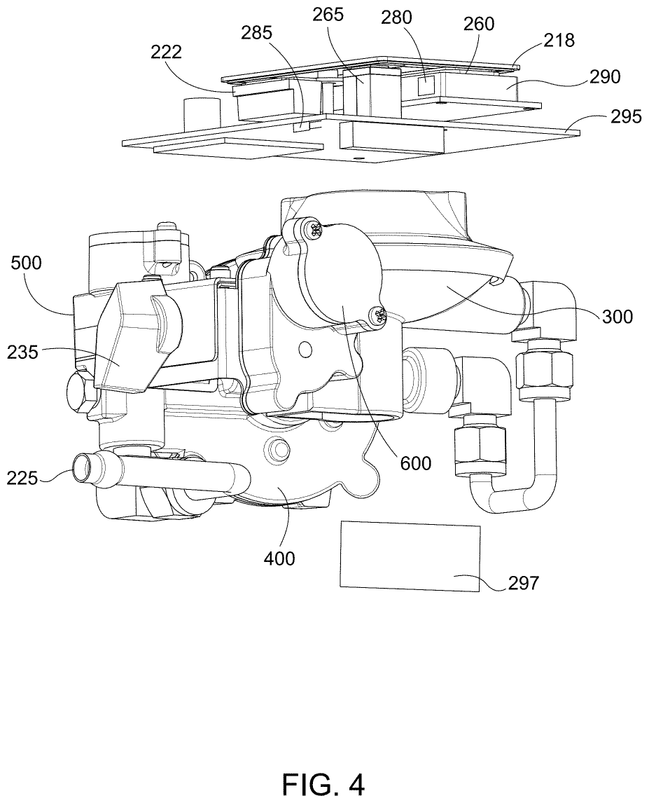

In some embodiments, the top cover 210 includes the diagnostic port 265. In some embodiments, the diagnostic port 265 is covered by the diagnostic port cover 270, which may be removable and may help protect the diagnostic port 265 from damage, such as that of debris or environmental conditions. In some embodiments, the diagnostic port 265 is a USB, USB mini, micro-USB, or similar type female port and is formed to mate with a male end of a correspondingly matched cord or device. In some embodiments, the diagnostic port may define a non-standard shape and require a proprietary or unique matched cord supplied by the distributor, service representative, or technician. The diagnostic port 265 may be electronically connected to components of the device 100, such as but not limited to one or more of a power supply, power source, data storage device, controller, control board, driver, display, sensor, actuator, motors, or processor component. A consumer or technician may engage the diagnostic port 265, such as with a connection cord and diagnostic device, to access information about the device 100 or to program, reprogram, or otherwise modify or manage electronic parameters of the device 100, which may be stored in a processing unit or storage unit. In some embodiments, a consumer or technician may electrically connect the device 100 with an external device via the diagnostic port 265 to charge the device's power source, such as a battery (see FIG. 4, battery 297).

A device outlet 225 may extend through an orifice defined by the housing 200, for example the lower enclosure 205 as shown in FIG. 2. In some embodiments, the device outlet 225 is formed as a tube or pipe and may be shaped to complement or mate with an adapter, a coupling feature or an inlet feature of a consumer appliance, such as the inlet of a cook stove, heater, refrigerator, generator, storage tank, etc. In some embodiments, the device outlet 225 fluidly connects the consumer appliance to the device 100.

FIG. 4 is an isometric view of the device 100 of FIG. 3 with the housing removed. FIG. 4 depicts the regulator assembly 300, the metering assembly 400, the valve assembly 500, the engagement feature 235, the device outlet 225, a battery 297, a latch box 222, security features 280, 285, the diagnostic port 265, the lid seal 218, a printed circuit board (PCB) 290, and a main board 295. FIG. 4 shows components that may be typically enclosed within the housing 200 or shielded from view by the top cover 210 and/or lower enclosure 205. The electronic screen 255 shown in FIG. 3 may be electronically connected to the PCB 290 and/or the main board 295, which may, in turn, be electronically connected to a jumper board and other electronic components (not pictured). These boards may also be electronically connected to a power source or power supply such as the battery 297. The main board 295 may have components including a combination of one or more processing elements, receivers, drivers, controllers, and data storage elements to store and be able to electronically communicate setup details, usage statistics, and other data about the device 100. In some embodiments the device 100 may be controlled from a remote, central server communication with the various electrical components of the device 100

A security feature 280 may be positioned below the top cover 210. The security feature 280 may be an electronic device that may be electronically connected to one or more of the PCB 290, main board 295, and/or other electrical components, sensors, and devices. The security feature 280 may be located in a protected chamber, for example one that is inaccessible to the consumer. In some embodiments, the protected chamber is defined by the underside of the user interface 230 and an upper surface of the PCB 290. In some embodiments, the security feature 280 may include a light detection element, an accelerometer, strain gauge, a location monitoring sensor, a GPS monitor, or a similar sensor. In embodiments where the security feature 280 includes a light detection element, the device 100 may be assembled so that light generally does not penetrate the housing 200 or top cover 210, so that light does not contact the security feature 280. In these embodiments, the security feature may be configured to send an alert when light contacts the security feature. In many embodiments, the security feature may be bypassed or deactivated when the device is not in use, or if the device is being serviced by an authorized person, such as a technician. In some embodiments, data from the security device 280, including a signal, alarm and/or the status thereof, may be communicated to a distributor, supplier, and/or authorized service technician. In many embodiments, if the security feature is activated and generates a signal, one or more communications components in the device 100 may provide a message, notice, or signal to a processing center or office indicating that the device is being or has been damaged and/or accessed by an unauthorized person. In some embodiments, the security feature, when activated, may signal the device 100 to stop or cease operation, such as going into various “safe” modes, such that fluid flow through the device is halted, until the security feature is re-programmed, turned off, or deactivated. In some embodiments, a data log of the status of the security feature 280 may be accessed remotely by a distributor or a supplier, or it may be accessed when the device 100 is serviced and data is transferred via the diagnostic port 265 or other communication method.

In some embodiments, the device may include a second security feature 285. In some embodiments, security feature 285 may be the same or similar to that of the first security feature 280. In some embodiments, the second security feature may be an electronic device that may be electronically connected to one or more of the PCB 290, main board 295, and/or other components. The second security feature 285 may also be located in a protected chamber that is inaccessible to the consumer. The protected chamber being defined by the underside of the main board 295. In some embodiments, the security feature 285 may be functionally similar to the security feature 280, but the different location of security feature 285 compared to security feature 280 may allow the security feature 285 to monitor a different aspect of the security of device 100.

In some embodiments, the device 100 may include both security features 280, 285 or only one security feature. In some embodiments, other security features similar to security features 280, 285 may be located within the device 100.

### Regulator Assembly 300

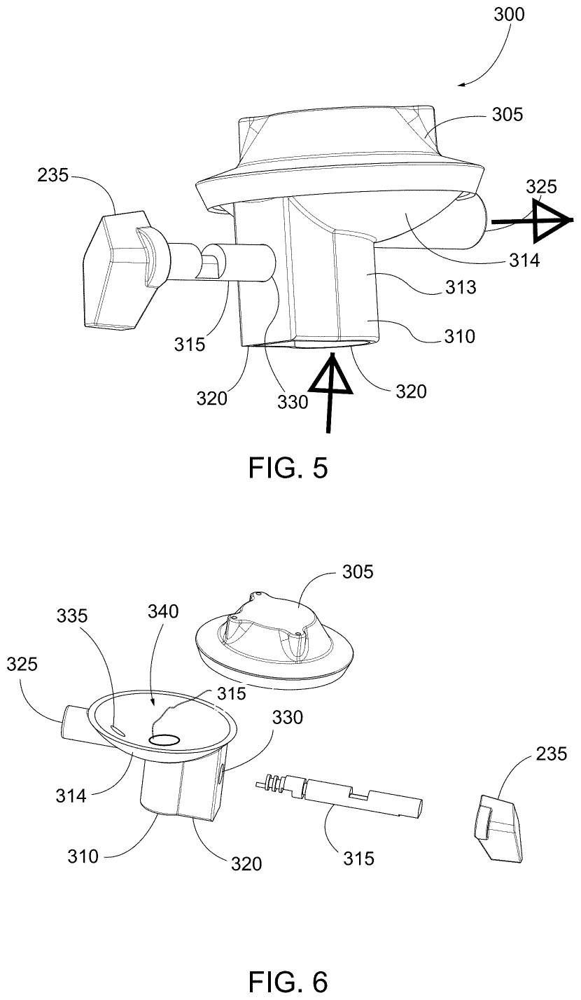

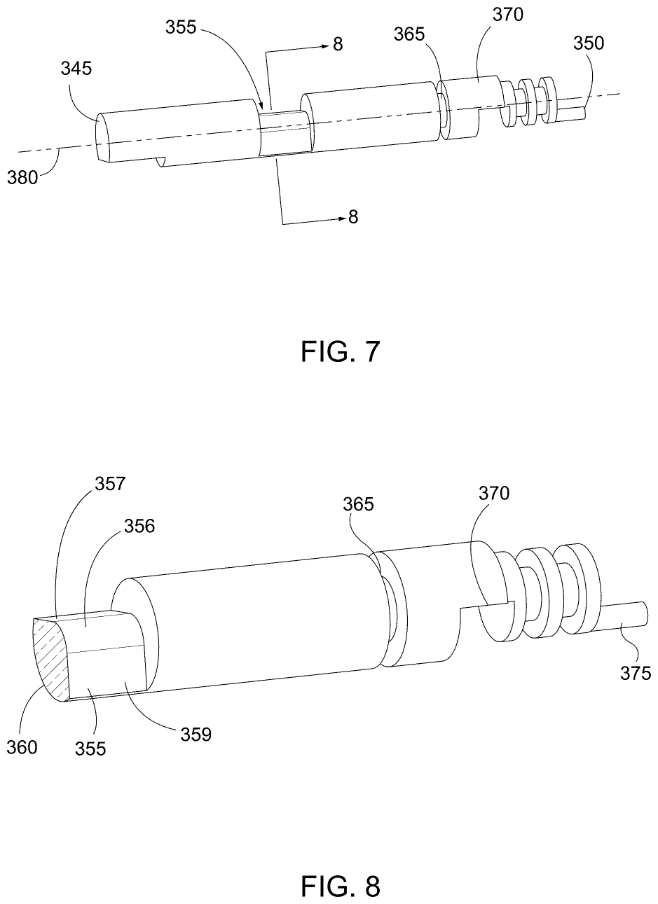

FIGS. 5-8 include various views the regulator assembly 300 and its components. FIG. 5 is an isometric view of the regulator assembly 300. FIG. 6 is an exploded view of the regulator assembly 300 of FIG. 5. FIG. 7 is an isometric view of a regulator key shaft. FIG. 8 is an isometric cross-sectional view along line 8-8 of the regulator key shaft 315 of FIG. 7.

In use, the regulator assembly 300 may be aid in regulating the pressure of the fluid entering the device 100. As shown in FIGS. 5 and 6, in some embodiments the regulator assembly 300 includes an inlet 320, a regulator top 305, regulator bottom 310, a regulator key shaft 315, and an outlet 325. Arrows in FIG. 5 indicate a fluid flow path. When assembled, the regulator top 305 may be positioned on and about the regulator bottom 310. The regulator bottom 310 may include a lower portion 311, an upper portion 313, and a regulator bowl 314. The regulator key shaft 315 may pass through a surface of the regulator bottom 310 at a key shaft aperture 330. In some embodiments, the key shaft aperture 330 is shaped to accept the regulator key shaft 315, and allow the regulator key shaft 315 to rotate, such that the key shaft aperture 330 is a circle.

FIG. 6 is an exploded view of the regulator assembly 300. In this view, the generally concave interior surface of the regulator bowl 314 is visible. This concave surface may help to form a chamber 340 for holding a fluid which may be received from the fluid supply. The chamber 340 may also be formed by an interior surface of the regulator top 305. In FIG. 6, the bowl inlet 316 is also visible.

The regulator assembly inlet 320 and regulator assembly outlet 325 may be fluidly connected with each other, depending on the position of the regulator key shaft 315. The outlet 325 may be fluidly connected to inlet 320 via the bowl inlet 316 and bowl outlet 335. The chamber 340 may fluidly connect the bowl inlet 316 and the bowl outlet 335.

In some embodiments, the inlet 320 is shaped and/or formed to be part of a coupling mechanism to couple the device with the fluid supply 50. In some embodiments, the coupling mechanism between the fluid supply 50 and the inlet 320 includes a quick-connect style connection coupled with a check valve.

FIGS. 7 and 8 show details of the regulator key shaft 315 of the regulator assembly 300. In some embodiments, the regulator key shaft 315 has a proximal end 345, a distal end 350, a key seat 355 formed by a flat faces 357, 359 and inner surface 356, a seal groove 365, a first regulator interface 370, a second regulator interface 375, and central axis 380.

The proximal end 345 is opposite the distal end 350. The central axis 380 extends along a length of the regulator key shaft 315 between the proximal end 345 and the distal end 350. The regulator key shaft 315 may have a generally cylindrical shape along its length with a generally circular cross-section.

As shown in FIG. 7, at its proximal end 345, the regulator key shaft 315 may have a partially circular shaped cross section. The proximal end 345 may be configured to receive the engagement device 235. The shape of the proximal end 345 may complement a portion of the engagement feature 235 (see FIG. 2). When assembled, the engagement feature 235 may be assembled, slid, or fastened onto the proximal end 345. In use, the rotation of the engagement feature 235 rotates the regulator key shaft 315. A consumer or technician may grasp the engagement feature 235 and rotate it. This rotation rotates the regulator key shaft 315. The rotation of the regulator key shaft 315 may secure the device 100 to the fluid supply and control the flow of fluid through the regulator assembly 300 and the device 100.

As shown in FIGS. 7 and 8, in some embodiments, a key seat 355 is adjacent the proximal end 345 of the regulator key shaft 315. The key seat 355 may not have a uniformly circular shaped cross-section. Instead, the key seat 355 maybe formed with the outer surface 360, two faces 357, 359, and the inner surface 356. The outer surface 360 may have an outer circumferential length of about 90 degrees or ¼ of the general circumference of the regulator key shaft 315. The faces 357, 359 may be generally flat and normal to each other and connected to each other via the outer surface 360 and an inner surface 356. The inner surface 356 may be slightly rounded or curved. In use, the key seat 355 may be engaged or create interference with components of the locking assembly 600 to prevent the device 100 from being incorrectly operated or removed from the fluid supply.

In some embodiments, the rotational position of the regulator key shaft 315 may control the formation of a fluid pathway from the fluid supply to the device 100. In some embodiments, the regulator key shaft 315 may be rotated to a position, for example a “User On” position, wherein a fluid within the fluid supply, cylinder, or storage tank may flow into the device 100 via the inlet 320, through the regulator assembly 300 and out of the outlet 325. The regulator key shaft 315 may be rotated into another position, for example a User Off position, wherein the fluid in the fluid supply is blocked or prevented from flowing from the storage tank into and through the regulator assembly 300. The regulator key shaft 315 may be rotated to an intermediate position between that of a User On and a User Off position, to partially block the fluid pathway through the regulator assembly 300. This intermediate position may allow a lower amount of fluid from the fluid supply to flow through the regulator assembly 300, and may, in some embodiments, allow the user to control the flow rate from the storage tank.

As shown in FIGS. 7 and 8, the regulator key shaft 315 may also include additional features to engage with the regulator assembly 300 and one or more structures at or near a valve on the fluid supply storage tank. In some embodiments, the regulator key shaft 315 also includes a seal groove 365. The seal groove 365 may be a groove formed in the regulator key shaft 315 such that a sealing element, such as an o-ring, rubber seal, etc., may be positioned within the seal groove 365. In use, the seal groove 365 may be used in the regulator assembly 300 to prevent a fluid from leaking out of the chamber 340 through the key shaft aperture 330.

As shown in FIGS. 7 and 8, the regulator key shaft 315 may also include a first regulator interface 370. The first regulator interface may have a semi-circular shaped cross-section. The shape of the first regulator interface 370 may correspond and complement features of the regulator assembly 300 and that of the fluid supply 50. In use, the first regulator interface 370 may be used to the help control the amount of fluid that may flow into the regulator assembly 300 from the fluid supply. The first regulator interface 370 may be also used to physically couple the device 100 to the fluid supply 50. The first regulator interface 370 may also be used in conjunction with a locking assembly 600 used to prevent the unauthorized removal of the device 100 from the fluid supply 50.

As shown in FIGS. 7 and 8, the distal end 350 of the regulator key shaft 315 may form a second regulator interface 375. In some embodiments, this includes a post extending in the direction of the central axis 380. The position of the second regulator interface 375 may be off-center from the central axis 380 of the regulator key shaft 315. In use, the second regulator interface 375 may be used to help control the amount of fluid that flows into and through the regulator assembly 300 from the fluid supply 50. In some embodiments, the second regulator interface 375 may be also used to physically couple the device 100 to the fluid supply 50. The second regulator interface 375 may also be used in conjunction with a locking assembly 600 used to prevent the unauthorized removal of the device 100 from the fluid supply 50.

In use, the regulator assembly 300 may be used to control an initial flow of fluid into the device 100 and regulate that flow to a desired pressure, flow rate, or combination thereof. The regulator assembly 300 may also be used to create a flow path between the fluid supply 50, the metering assembly 400 and the valve assembly 500 of the device 100, or to block, stop, or prevent a fluid flow path between the fluid supply 50 and the device 100.

In use, the regulator assembly 300 may interact with the locking assembly 600 to secure the device 100 to the fluid supply 50.

### Locking Assembly 600

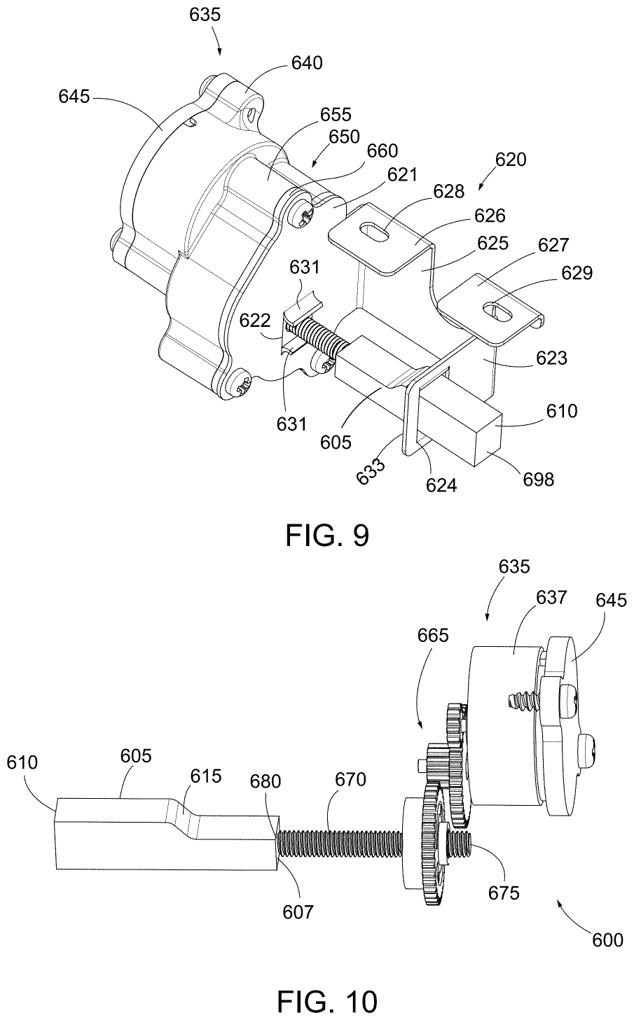

FIGS. 9 and 10 show a locking assembly. FIG. 9 is an isometric view of a locking assembly 600. FIG. 10 is an isometric view of the locking assembly 600 of FIG. 9 with motor housing, mount plate, and gear housing removed. The locking assembly 600 may include a locking shaft 605, a threaded rod 670, a mount plate 620, and a motor assembly 635. As shown in FIG. 9, the mount plate 620 includes a proximal end 621, aperture 622, a distal end 623, aperture 624, a front end 625, a proximal upper member 626, an aperture 628, a distal upper member 627 and an aperture 628. As shown in FIG. 10, the motor assembly 635 may include a motor base 645, motor housing (FIG. 9), an electric motor 637, and a gear assembly 650, a gear housing 655 (FIG. 9) and a gear lid 660 (FIG. 9).

The motor assembly 635 may include the electric motor 637 housed in the motor base 645 and the motor housing 635. An output shaft of the motor 637 may be coupled to a gear assembly 665. The gear assembly 665 may be positioned within the gear housing 655 and the gear lid 660. The mount plate 620 may be coupled to the gear lid 660 via fasteners. As shown in FIG. 10, the locking shaft 605 may be coupled to the gear assembly 665. In use, the locking shaft 605 may be linearly translated with respect to the mount plate 620. The movement of the locking shaft 605 helps to secure the device 100 to the fluid supply or storage tank.

As shown in FIG. 9, the locking assembly 600 includes the mount plate 620. In some embodiments the mount plate 620 includes proximal end 621 and distal end 623 of the mount plate 620 may be generally planar. The proximal end 621 and distal end 623 may be generally parallel with each other. A proximal end aperture 622 is formed in the proximal end 621 and may include wings 631 extending towards the distal end 623. The proximal end aperture 622 may be sized to allow a proximal end of the locking shaft 605 to be inserted through and linearly translated within it. A distal end aperture 624 is formed in the distal end 623 and may include wings 633 extending towards the proximal end 621. The distal end aperture 624 may be sized to allow a distal end of the locking shaft 605 to be inserted and linearly translated within it. The wings 631, 633 may be used to support the locking shaft 605 and align the locking shaft 605 with the respective apertures 622, 624. The apertures 622, 624 may provide additional support to the locking shaft 605 to prevent deformation of the locking shaft 605 if an unauthorized removal of the device from the fluid supply is attempted.

In some embodiments, with continued reference to the mount plate 620, the generally planar front member 625 connects the proximal end 621 and distal end 623. The front face 625 is generally normal to the proximal end 621 and distal end 623. The proximal upper member 626 and distal upper member 627 are formed extending from the top of the front member 625. The proximal upper member 626 and distal upper member 627 are generally normal to the front member 625 as well as the proximal end 621 and distal end 623. The proximal upper member 626 and distal upper member 627 may include apertures 628, 829 to allow fasteners to be inserted there through so that the mount plate 620 may be attached or coupled to portions of the device 100. In use, the mount plate 620 may help support the locking shaft 605 when the device is in an unlocked position.

As shown in FIG. 10, the motor assembly 635 may include the gear assembly 665. The gear assembly 665 may include multiple sprockets that may be meshed together to convert the power and rotational speed from the output shaft of the motor 637 into a slower rotational speed of the output of the gear assembly 665. The gear assembly 665 is threadably coupled to a threaded rod 670. The threaded rod 670 has a proximal end 675 and a distal end 680. In some embodiments, the output of the gear reduction drive 665 is threadably positioned about the proximal end 675 of the threaded rod 670. The threaded rod 670 is coupled to the locking shaft 605. The locking shaft 605 has a proximal end 607 and a distal end 610 and a shoulder positioned between the proximal end 607 and the distal end 610. The proximal end 607 has a height that is smaller than a height of the distal end 610. The distal end 610 is taller than the proximal end 607. The distal end of the threaded rod 670 may be coupled to the proximal end 607 of the locking shaft 605. In some embodiments, the motor assembly 635 does not use a gear assembly to decrease the rotational output speed of the motor. In some embodiments, the motor is a servo motor.

In use, the motor 670 is engaged to linearly adjust the position of the distal end 610 of the locking shaft 605 is to extend into the distal end aperture 624. As the motor 637 is engaged to rotate in a first direction, the threaded rod 670 and locking shaft 605 are linearly moved in a first direction by way of rotation of the gear assembly 665 and the threaded engagement of the output of the gear assembly 665 with the threaded rod 670. As the motor 637 is engaged to rotate in an opposite direction, the threaded rod 670 and locking shaft 605 are linearly moved in an opposite direction.

As shown in FIG. 9, the distal end 610 of the locking shaft 605 extends through the distal end aperture 624 of the mount plate 620. When the distal end 610 of the locking shaft 605 is positioned within the distal end aperture 624, the locking assembly 600 is in an unlocked position 698.

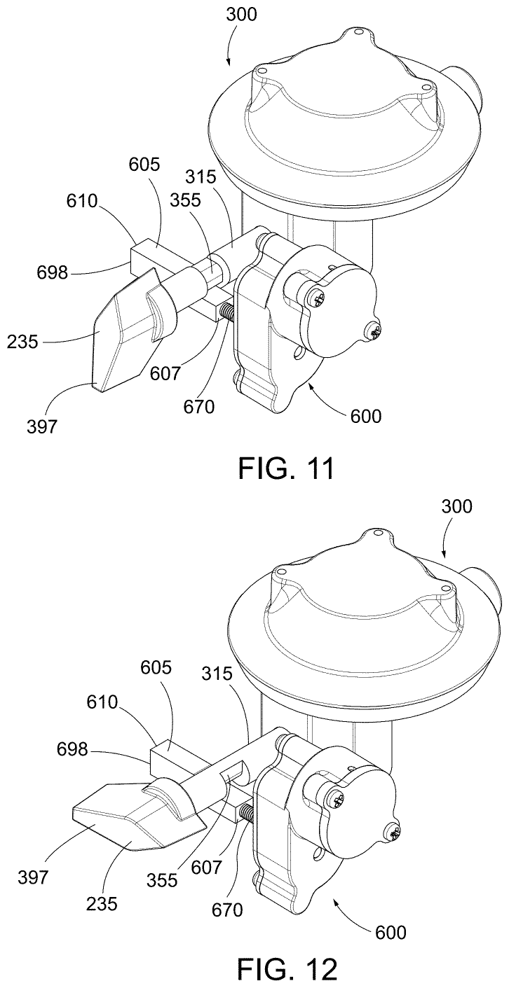

In a locked position (described below), the locking shaft 605 engages with the key seat 355 of the regulator key shaft 315. The position of the key seat 355 prevents the rotation of the regulator key shaft 315 into the position 397 shown in FIG. 11. In this position, the device 100 is not removable from the fluid supply without application of force that may trigger an alarm or shutdown of the device. In order for the device 100 to be removed from the fluid supply, the locking shaft is moved so that it no longer prevents the free rotation of the regulator key shaft 315. To accomplish this, the motor 637 is be engaged to rotate to thereby move the threaded rod 670 and attached locking shaft 605. In some embodiments, the motor 637 may be activated remotely in order to adjust the position of the locking shaft 605 with respect to the aperture 624.

FIGS. 11-15 show the interaction between the rotational position of the regulator key shaft 315 and the locking shaft 605.

FIG. 11 is an isometric view of a locking assembly and a regulator assembly with the mounting plate removed, the locking assembly positioned in an unlocked position 698 and the regulator key shaft 315 and engagement feature 235 are positioned in a first position 397. In the first position 397, or a disconnect position 397, the regulator assembly 300 is not physically secured or fluidly coupled to the fluid supply.

FIG. 12 is an isometric view of the locking assembly and regulator assembly, with the mounting plate removed, the locking assembly 300 positioned in the unlocked position 698 and the regulator key shaft 315 and engagement feature 235 positioned in a second position 398. In the second position 398, the regulator assembly 300 is physically coupled to the fluid supply, but it is not fluidly coupled to the fluid supply. In some embodiments, this physical connection includes an interaction between the first regulator interface 370, the second regulator interface 375, the inlet 320, or a combination thereof with a feature of the fluid supply. The second position 398 may also be referred to as the “User Off” position 398. In the User Off position 398, fluid from the fluid supply 50 will not flow into and through the regulator assembly 300. Therefore, in the User Off position 398, fluid from the fluid supply 50 will not flow through the device 100.

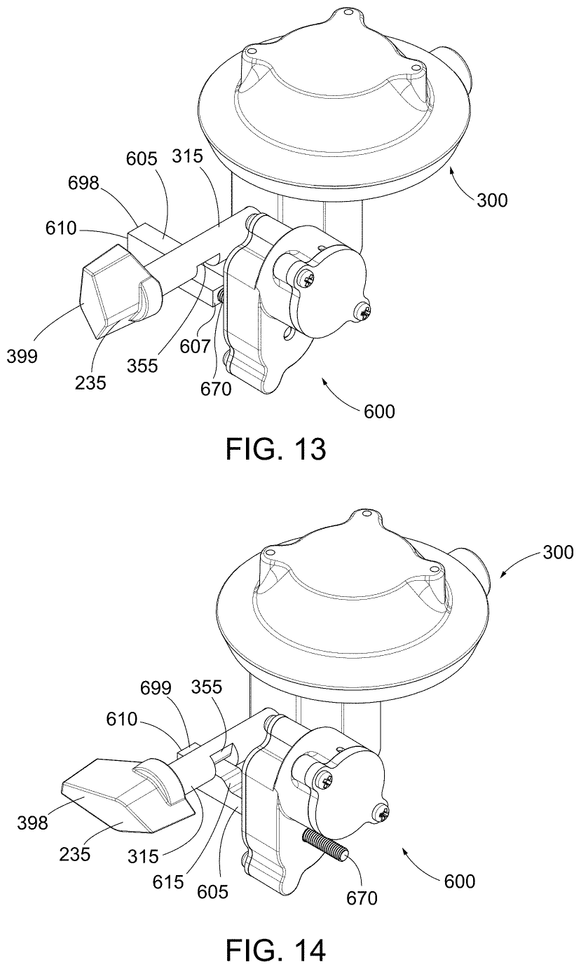

FIG. 13 is an isometric view of the locking assembly and regulator assembly, with the mounting plate removed, the locking assembly positioned in an unlocked position 698 and the regulator key shaft 315 and engagement feature 235 positioned in a third position 399. In the third position 399, the regulator assembly 300 is physically and fluidly coupled to the fluid supply 50. In some embodiments, an interaction between the first regulator interface 370, the second regulator interface 375, the inlet 320, or a combination thereof with a feature of the fluid supply creates the fluid coupling. Third positon 399 may also be referred to as the “User On” position 399. In the User On position 399, fluid from the fluid supply 50 may flow into and through the regulator assembly 300. Therefore, in the User On position 399, fluid from the fluid supply 50 will flow into and through the device 100 (provided there are not restrictions downstream of the regulator assembly 300 and within the device 100).

In FIGS. 11-13, the regulator key shaft 315 may be freely rotated between positions 397, 398, 399. The locking shaft 605 does not impinge or prevent the rotation of the regulator key shaft 315 from positions 397, 398, or 399. The key seat 355 of the regulator key shaft 315 is positioned adjacent the proximal end 607 of the locking shaft 605, which has a shorter height than the distal end 610 of the locking shaft 605.

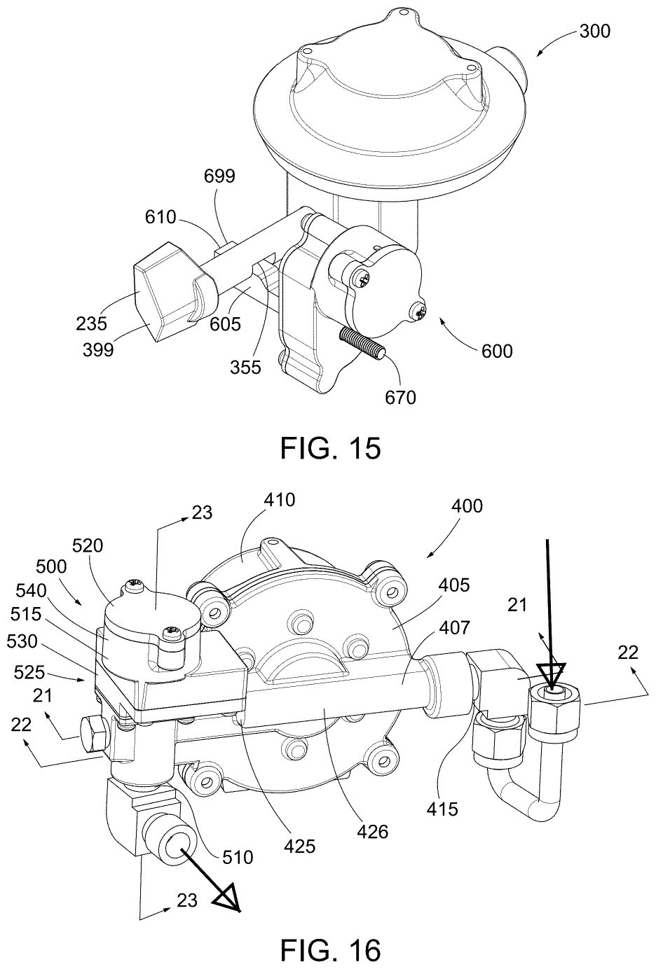

FIGS. 14 and 15 are isometric views of the locking assembly and regulator assembly, with the mounting plate removed, the locking assembly positioned in a locked position 399 and the regulator key shaft positioned in a second/User Off position 398 (FIG. 14) and in the third/User On position 399 (FIG. 15). When the locking assembly 600 is positioned in the locked position 399, the locking shaft 605 is linearly moved towards the motor assembly 635. When in the locked position 699, the key seat 355 is positioned about the taller distal end 610 of the locking shaft 605. In the locked position 699, the regulator key shaft 315 may be rotated between the User Off position 398 (see FIG. 14) and User On position 399 (see FIG. 15). The regulator key shaft 315 may not be rotated into the disconnected position 397. (i.e. 90 degrees counter clockwise form the User Off position 398) With the locking shaft 605 in the locked position 699, the distal end 610 of the locking shaft may contact the face 359 of the key seat 355, and prevent the rotation of the regulator key shaft 315 into the first position 397.

In use, a technician or distributor may install the device 100 onto a fluid supply 50 with the locking assembly 600 in the unlocked position 698 and the regulator assembly 300 in the disconnect position 397. The technician or distributor may then engage the engagement feature 235, for example by grasping a handle and rotating it 90 degrees clockwise, to change from the disconnect position 397 to the user off position 398. The technician or distributor may then send a signal to the device 100 to engage the locking assembly 600 to move the locking shaft 605 into the locked position 699. The device 100 may receive the signal and engage the motor assembly 635 and thereby linearly move the locking shaft 605. Once the locking assembly is in the locked position 699, the user may still turn on and off the fluid supply by rotating the engagement feature 235 between positions 398 and 399. However, the device 100 cannot be removed or separated from the fluid supply. This security feature may help prevent the unauthorized removal of the device from the fluid supply. If an authorized removal of the device is indicated, a technician or distributor may send a signal to the device initiating an electronic signal to activate the motor and move the locking shaft 605 into the unlocked position 698.

### Metering Assembly 400

The metering assembly 400 may be used to measure the flow of the fluid through the device 100. In some embodiments, the metering assembly may be used with measure flow rates between 5 L/hour and 400 L/hour of a fluid comprising a mixture from about 0 to 100% butane and about 100% to 0% propane. In most embodiments, where the fluid is a gas, the gas is regulated to about 30 mbar. In some embodiments, the metering assembly may have a generally minimum flow rate of approximately 8.5 L/hour (0.005 cfm). In some embodiments, the minimum flow rate is higher or lower than 8.5 L/hour (0.005 cfm). In some embodiments, the metering assembly may have a generally maximum flow rate of approximately 2700 L/hour (1.6 cfm). In some embodiments, the maximum flow rate is higher or lower than 2700 L/hour (1.6 cfm). In some examples, the meter accuracy may be in the range of about +/−2%. In some examples, the meter accuracy may be in the range of about +/−1%. In some embodiments using LPG with a type of cooking appliance, the range may be between 10 L/hour (0.006 cfm) and 300 L/hour (0.177 cfm). In some embodiments using LPG with a type of cooking appliance, the range may be between about 15 L/hour (0.009 cfm) to about 250 L/hour (0.147 cfm). In some embodiments, the minimum flow rate using LPG with a cooking appliance is higher than about 5L/hr, 6 L/hr, 7 L/hr, 8 L/hr, 9 L/hr, 10 L/hr, 11 L/hr, 12 L/hr, 13 L/hr, 14 L/hr, 15 L/hr, 20 L/hr, 30 L/hr, 40 L/hr, 50 L/hr, 60 L/hr, 70 L/hr, 80 L/hr, 90 L/hr, 10 L/hr, 150 L/hr, 200 L/hr, or 250 L/hr, and less than about 300 L/hr, 250 L/hr, 200 L/hr, 150 L/hr, 100 L/hr, 90 L/hr, 80 L/hr, 70 L/hr, 60 L/hr, 50 L/hr, 40 L/hr, 30 L/hr, 20 L/hr, 15 L/hr, 14 L/hr, 13 L/hr, 12 L/hr, 11 L/hr, 10 L/hr, 9 L/hr, 8 L/hr, 7 L/hr, 6 L/hr, or 5 L/hr. In some embodiments, the maximum flow rate using LPW with a cooking appliance is higher or lower than 250 L/hour (0.147 cfm).

In some embodiments, the metering assembly 400 may include a vortex flow meter for measuring fluid flow. In some embodiments, the vortex flow meter may be a fluidic oscillator. Fluidic oscillators may generate a periodic flow output from a steady fluid inflow.

In some embodiments, fluidic oscillators may enable the metering of flow without moving parts. Oscillation of the flow stream is produced in fixed-geometry cavities due to hydrodynamic instabilities. In some embodiments, the flow of fluid may be directed through one or more metering plates having two or more channels for accepting the oscillating flow. In some embodiments, a sensor may be positioned at or near a flow channel to monitor the oscillating flow. In some embodiments the sensor may be a piezoelectric sensor, for example a ceramic piezo sensor that may oscillatingly deform the ceramic piezo. These deformations may cause a signal to be produced. The signal is transmitted through the piezo sensor to one or more device components, for example the processing unit. The processing unit may calculate a fluid flow rate from the signal frequency rate. In other embodiments, other types of flow measurement components may be used.

In some embodiments, the use of a vortex flow meter to calculate a fluid flow rate may use a smaller or lower amount of electric power than other fluid measuring systems because the electrical signal is generated by the piezoelectric effect. This may be desirable because in some embodiments, the device may be operated in remote areas without consistent electrical power available, and a battery may be used to power the various other features of the device, such as the display, the motors for the locking assembly and valve, and other electronic processing and sending/receiving and communications components. For these reasons, a long battery life may be desirable and a component that does not draw energy, such as a sensor based on piezoelectrics may be preferred. In addition, while some embodiments may allow the user to recharge the power source, in some embodiments, a user may not have the ability to replace a power source without activating a security feature.

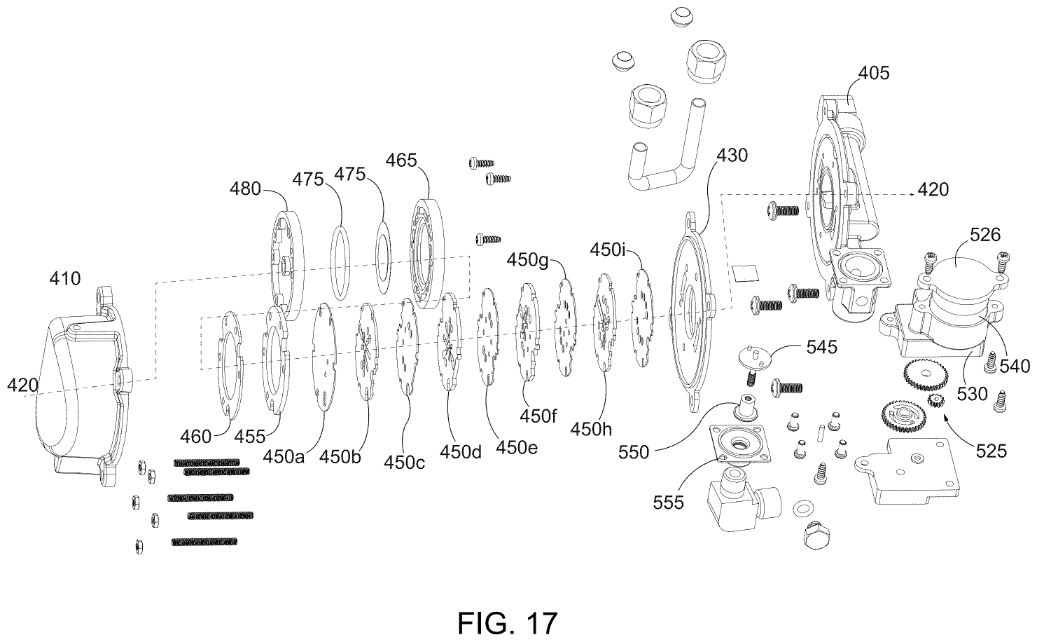

FIGS. 16-23 are various views of the metering assembly 400 and valve assembly 500 and their components. FIG. 16 is an isometric view of the metering assembly 400 and the valve assembly 500. FIG. 17 is an exploded view of FIG. 16.

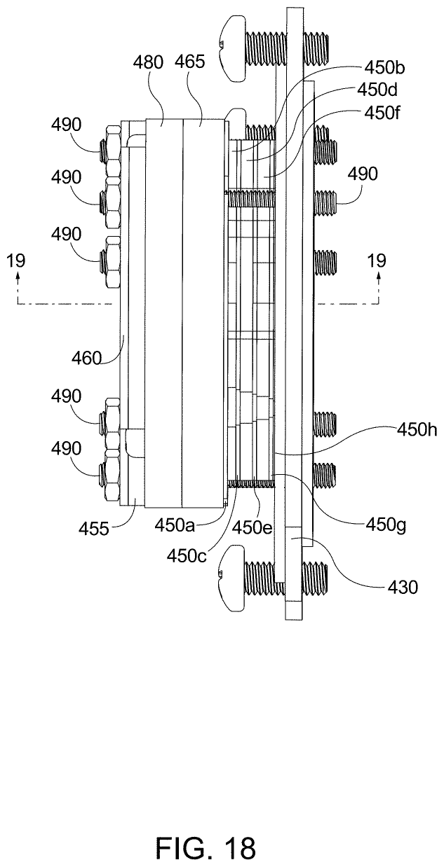

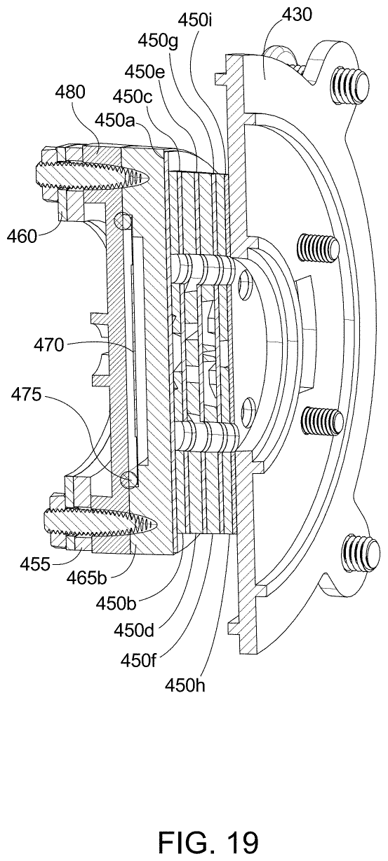

As shown in FIG. 17, the upper housing 405 and lower housing 410 may contain the components to form a fluidic oscillator-style flow meter. In some embodiments, the upper housing 450 is coupled with a lower housing 410 via fasteners or other connection features to contain the components of the metering assembly 400. The metering assembly 400 may also include a meter seal 430, metering plates 450a, 450b, 450c, 450d, 450e, 450f, 450g, 450h, 450i, a piezo damper 455, a piezo hold down 460, a sensor lower casing 465, a piezo ceramic element 470, a sealing member 475, a sensor upper casing 480. FIGS. 18 and 19 show details of the features of the metering assembly 400, including the layout the metering plates.

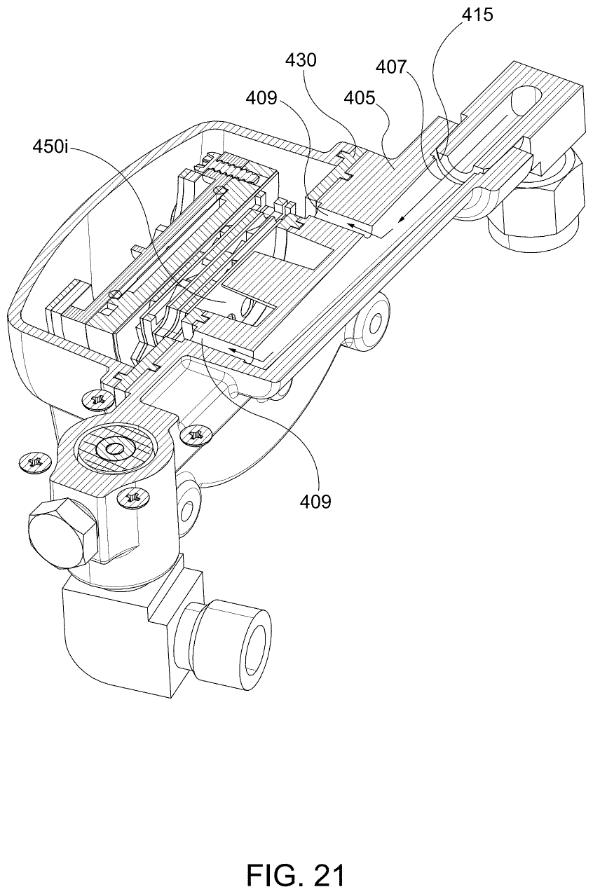

FIG. 21 shows the general inlet features of the metering assembly 400 with arrows indicating a flow path. FIG. 21 is a cross-sectional view along line 21-21 of the metering assembly and valve assembly of FIG. 16. The outlet 325 (see FIG. 5) of the regulator assembly 300 may be fluidly connected to the inlet 415 of the metering assembly 400. The inlet 415 may be fluidly connected to an intake manifold 407. The intake manifold 407 may be formed in the upper housing 405. The intake manifold 407 may be fluidly connected to inlet ports 409. The inlet ports 409 may also be formed in the upper housing 405. The inlet ports 409 may fluidly connect to an inlet area 442i of metering plate 450i. A fluid flow path into the inlet 415, the inlet ports 409, and into the inlet area 442i is shown in FIG. 21.

In some embodiments, the inlet area 442i of metering plate 450i is adjacent the housing inlet ports 409, with the corresponding inlet areas of plates 450h, 450g, 450f, 450e, 450d, 450c and 450b fluidly connected in order. In addition, plates 450b-450i includes oscillation ports 444, control ports 445, vent ports 446, control transfer ports 447, and vent transfer ports 448 that may help conduct the fluid flow towards or away from the piezo sensor 470. In some plate embodiments, at least one inlet area 442 is fluidly connected to the control ports 445, the vent ports 446, and the oscillation ports 444 of the corresponding plate.

The fluid flow through the ports 440 in plate 450a oscillates due to the shape of features in plate 450b. The shapes and layouts of the various ports in plates 450b-450i help the flow of fluid exit the metering assembly 400. The combination of ports in the various plates may also help enable the frequency of the fluid oscillation in ports 440 to be more easily measured.

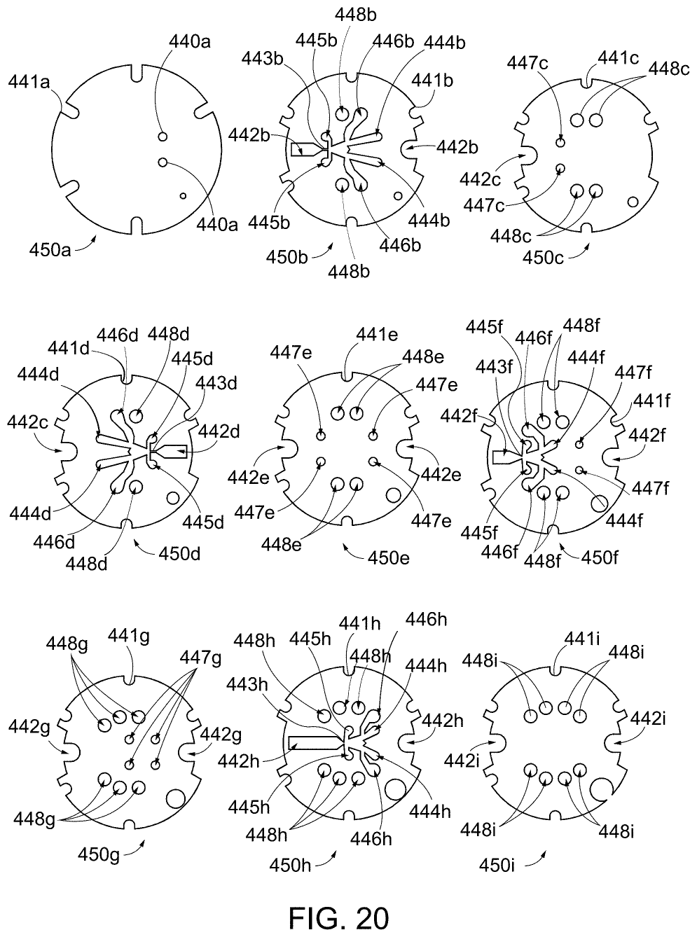

Details of the metering plates will now be described with reference to FIG. 20. Regarding FIG. 20, similar components follow a similar naming convention. For example, a fastener groove of a metering plate corresponds to 441, an inlet area of a metering plate corresponds to 442, a throat of a metering plate corresponds to 443, an oscillation port of a metering plate corresponds to 444, a control port of a metering plate corresponds to 445, a vent port of a metering plate correspond to 446, a control transfer port of a metering plate correspond to 447, and a vent transfer port of a metering plate correspond to 448. The piezo ceramic element 470 may be fluidly connected to the first metering plate 450a by way of two ports to the ceramic piezo 440. In some embodiments, the inlet areas 442 of each metering plate 450b-450i may be fluidly connected to the inlet ports of the upper housing 405.

Plate 450i includes 8 vent transfer ports 448i and 2 inlet areas 442i. The 8 vent transfer ports 448i of plate 450i are fluidly connected to 6 vent transfer ports 448h and 2 vent ports 446h of plate 450h. The 2 inlet areas 442i are fluidly connected to the 2 inlet areas 442h.

Plate 450h includes 6 vent transfer ports 448h, 2 vent ports 446h, 2 control ports 445h, 2 oscillation ports 444h, one throat 443h, and 2 inlet areas 442h. 2 of the vent ports 446h of the plate 450h are fluidly connected to the 2 oscillation ports 444h, 2 control ports 445h, and a throat area 443h leading to an inlet area 442h. The 2 oscillation ports 444h and 2 control ports 445h are fluidly connected to 4 control transfer ports 447g of plate 450g. In addition, all 6 vent transfer ports 448h are fluidly connected to the 6 vent transfer ports 448g of plate 450g. The 2 inlet areas 442h are fluidly connected to the 2 inlet areas 442g.

Plate 450g includes 6 vent transfer ports 448g, 4 control transfer ports 447g, and 2 inlet areas 442g. 4 vent transfer ports 448g of plate 450g are fluidly connected to 4 vent transfer ports 448f of plate 450f. 2 vent transfer ports 448g are fluidly connected to 2 vent ports 446f of plate 450f. 2 of the control transfer ports 447g are connected to 2 control transfer ports 447f of plate 450f. 2 of the control transfer ports 447g are connected to 2 oscillation ports 444f of plate 450f. The 2 inlet areas 442g are fluidly connected to the 2 inlet areas 442f.

Plate 450f includes 2 inlet areas 442f, one throat 443f, 2 oscillation ports 444f, 2 control ports 445f, 2 vent ports 446f, 2 control transfer ports 447f, and 4 vent transfer ports 448f. The 2 oscillation ports 444f are fluidly connected to the 2 vent ports 446f and the 2 control ports 445f, and further fluidly connected to throat 443f and one inlet 442f. The 2 control transfer ports 447f fluidly connected to 2 control transfer ports 447e of plate 450e. The 2 control ports 445f are fluidly connected to an additional 2 control transfer ports 447e. The 4 vent transfer ports 448f are fluidly connected to 4 vent transfer ports 448e of plate 450e. The 2 inlet areas 442f are fluidly connected to 2 fluid inlet areas 442 of plate 442e.

Plate 450e includes 2 inlet areas 442e, 4 control transfer ports 447e, and 4 vent transfer ports 448e. 2 of the control transfer ports 447e are fluidly connected to 2 of the control ports 445d of plate 450d. 2 other of the control transfer ports 447e are fluidly connected to 2 of the oscillation ports 444d of plate 450d. 2 of the vent transfer ports 448e are connected to 2 of the vent transfer ports of 448d. The other 2 vent transfer ports 448e are fluidly connected to 2 vent ports 446d of plate 450d. Inlet areas 442e are fluidly connected to inlets areas 442d.

Plate 450d includes 2 inlet areas 442d, one throat 443d, 2 oscillation ports 444d, 2 control ports 445d, 2 vent ports 446d, and 2 vent transfer ports 448d. 2 of 448e are fluidly connected to 2 of the vent transfer ports 448c of plate 450c. 2 of oscillation ports 444d are fluidly connected to 2 of vent ports 446d, 2 of the control ports 445d, one throat 443d and one inlet 442d. 2 of the vent transfer ports 448d are fluidly connected to 2 vent transfer ports 448c. 2 of the vent ports 446d are fluidly connected to another 2 of vent transfer ports 448d. The 2 oscillation ports 444d are fluidly connected to 2 control transfer ports 447c. One inlet 442d is fluidly connected with the inlet 442c of plate 450c.

Plate 450c includes one inlet area 442c, 2 control transfer ports 447c, and 4 vent transfer ports 448c. The inlet area 442c is fluidly connected to one inlet area 442b of 450b. The 2 control transfer ports 447c are fluidly connected to the control ports 445b. 2 of the vent transfer ports 448c are fluidly connected to 2 vent transfer ports 448b of plate 450b. The other 2 of the vent transfer ports 448c are fluidly connected to 2 vent ports 446b.

Plate 450b includes 2 inlets areas 442b, one throat 443b, 2 oscillation ports 444b, 2 control ports 445b, 2 vent ports 446b, and 2 vent transfer ports 448b. The 2 oscillation ports 444b are fluidly connected to the 2 ports to the piezo 440a of plate 450a.

In use, the flow of the fluid through ports 440a of plate 450a and against the ceramic element 470 causes periodic vibration/deformation of the ceramic element 470. Each deformation generates a signal. The ceramic element 470 is electrically connected to various electronic components of the device 100 to transmit this signal.

At the same time, known parameters of the fluid supply 50 and environmental conditions may be recorded or retrieved from storage and transmitted to the device 100. For example, the parameters may include a volume of the fluid supply, an initial composition of the fluid, the current temperature and atmospheric pressure, a unit specific flow calibration, etc.

A component of the device 100, or example the central processing unit, may then process the signals to generate a signal rate. The signal rate may then be converted (using techniques well known to those in the art) to a volumetric flow rate and into a mass flow rate for the fluid flowing through the metering assembly 400.

FIGS. 18 and 19 show details of how the internal components of the metering assembly 400 maybe positioned. As shown in FIGS. 18 and 19, the sensor upper casing 480 and sensor lower casing 465 may be positioned adjacent each other. The piezo ceramic element 470 may be positioned within the sensor upper casing 480 and sensor lower casing 465 and adjacent a seal 475, such as an o-ring. Adjacent the sensor upper casing 480, opposite the sensor lower casing 465, may be the piezo damper 455 and piezo hold down 460. Fasteners 490 may extend through the piezo hold down 460, the piezo damper 455, the sensor upper casing 480, the sensor lower casing 465, and the fastener grooves 441 of the various metering plates to help hold the metering assembly components together. The piezo damper 455 and piezo hold down 460 may be used to help isolate the piezo ceramic element 470 from outside vibrations, such as those in the device 100 as well as external the device 100.

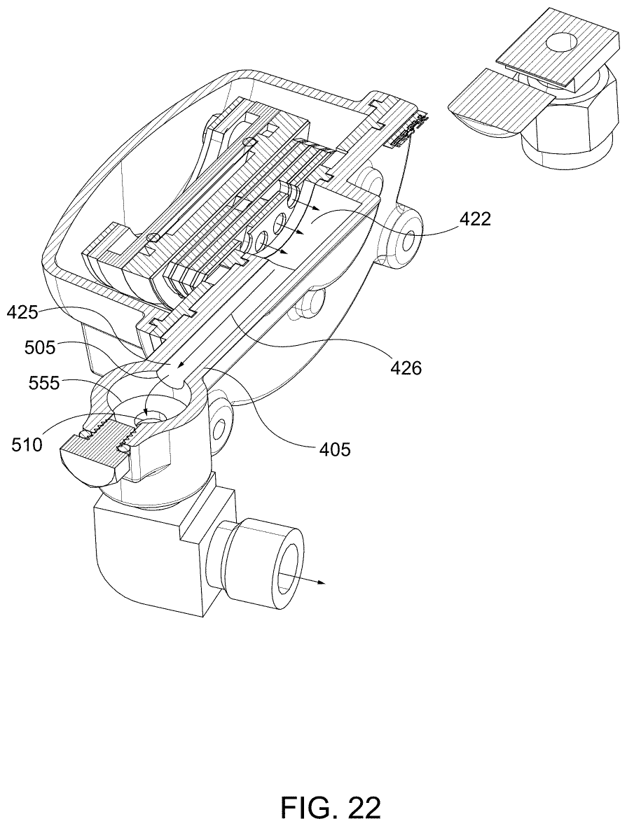

FIG. 22 shows various details of how fluid may exit the metering assembly 400. FIG. 22 is a cross-sectional view along line 22-22 of the metering assembly 400 and valve assembly 500 of FIG. 16. FIG. 22 shows how the various ports of the meter plates are fluidly connected to an outlet port 422 formed in the upper housing 405. The outlet port 422 fluidly connects to an outlet manifold 426 formed in the upper housing 405. The outlet manifold 426 is fluidly connected to the outlet 425 of the metering assembly 400. The outlet 425 of the metering assembly 400 is fluidly connected to the inlet 505 of the valve assembly 500. In use, as fluid exits the metering plates, it will travel through the manifold 426, out of the metering assembly outlet 426, and into the inlet 505 of the valve assembly 500.

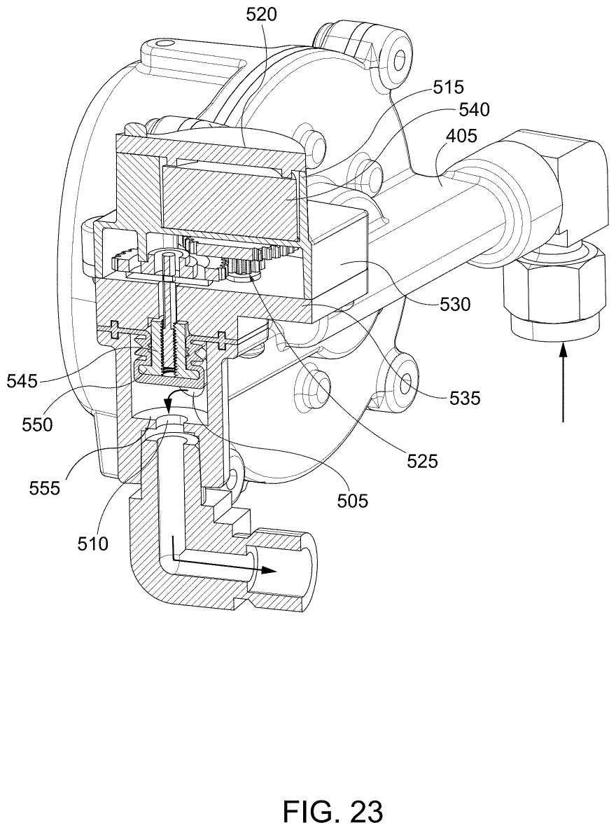

FIG. 23 shows one embodiment of the valve assembly 500. FIG. 23 is a cross-sectional view along line 23-23 of the metering assembly 400 and valve assembly 500 of FIG. 16. In some embodiments, the valve assembly 500 includes the inlet 505, an outlet 510, a motor housing 515, a motor cap 520, a gear assembly 525, a gear housing 530, a gear lid 535, a motor 540, a valve drive gear 545, a valve drive nut 550, and a valve drive seal 555.

In some embodiments, the valve assembly 500 functions as a remote shutoff valve and is in the form of a plunger valve assembly. In some embodiments, other types of a valves may be used to create remote shutoff valve. The valve assembly 500 may include the motor housing 515 with the motor cap 520 that encloses the motor 540. The valve assembly 500 may also include the gear assembly 525 positioned within the gear housing 530 and the gear lid 535. The gear assembly 525 may be used to convert the rotational speed and motion of the motor 540 to a slower speed via the gear assembly 535 and translate the rotational movement into linear movement of a valve drive nut 550. In some embodiments, a gear assembly 525 is not used to decrease the rotational speed that is used to engage the valve drive nut. In some examples, the motor 540 may be a servo motor.

In some embodiments, the gear assembly 525 may be connected to the valve drive gear 545. The valve drive gear 545 may be coupled to the drive nut 550 that may be positioned above the valve drive seal 555. The area between the valve drive seal 555 and the drive nut 550 may form a chamber that is fluidly connected to the inlet 505 and outlet 510 of the valve assembly 500. In some embodiments, the outlet 510 of the valve assembly is fluidly coupled to the device outlet 225. A flow path of fluid through the valve assembly is shown in FIG. 23 by arrows.

The motor 540 and gear assembly 535 may be used to linearly move the drive nut 550 towards and away from the valve drive seal 555 to maintain the fluid connection between the inlet 505 and the outlet 510, or to break the fluid connection. In a first position, as shown in FIG. 21, the valve drive nut 550 is positioned away from the valve drive seal 555 and a fluid pathway is formed between the inlet 505 and the outlet 510 of the valve assembly 500, such that the inlet 505 and the outlet 510 are fluidly connected. In a second position, the valve drive nut 550 is positioned adjacent the valve drive seal 555, creating a seal such that the inlet 505 and outlet 510 are no longer fluidly connected.

In use, the valve assembly 500 may be remotely operated in response to a variety of triggering events. In some embodiments, once a consumer has paid for a supply of fluid, the valve assembly 500 may be opened responsive to a signal that a predetermined quantity of fluid has been paid for such that fluid from the fluid supply may flow through the device 100 and out of the outlet 510 of the valve assembly 500. Upon an indication that a predetermined quantity of fluid has been distributed from the fluid supply, the valve assembly 500 may be programmed to close responsive to a second signal, thereby cutting off the fluid pathway. In some embodiments, the valve assembly 500 may also be remotely and automatically closed responsive to a third signal that is based upon a status of the security feature of the housing or a system event, such as an attempted unauthorized access. In some embodiments the credit on the meter can be used for collateral for loans or installment payment plans for other products, with the valve assembly 500 being remotely shut off due to default on the loan or installment payment even if the customer still has credit on the meter.

### Assembly

The regulator top 305, regulator bottom 310, and regulator key shaft 315 may be assembled. In some embodiments, the regulator assembly 300 may be a LPG regulator that is standard or typical for a given country. In some embodiments, the regulator assembly 300 may be configured to ensure the regulator key shaft 315 fits with the locking assembly 600 and the capacity of the regulator assembly 300 is appropriate for the fluid being regulated.

In some embodiments, the locking assembly 600 is then coupled to the regulator assembly 300. The mount plate 620 of the locking assembly 600 may be installed about the regulator key shaft 315, and the locking shaft 605 may then be installed to appropriately interface with the regulator key shaft 315.

The inlet 515 of the metering assembly 400 may then be fluidly connected to the outlet 325 of the regulator assembly 300. This connection may be via hard tubing, metal piping, hose, or other suitable connection materials appropriate for the fluid that will flow through the device 100. The outlet 425 of the metering assembly 400 is then fluidly connected to the inlet 505 of the valve assembly 500. In some embodiments, the metering assembly 400 and the valve assembly 500 may be manufactured as a single assembly.

In some embodiments, the device outlet 225 may be fluidly connected to the outlet 510 of the valve assembly 500.

After the regulator assembly 300, the metering assembly 400, the valve assembly 500, and the locking assembly 600 are coupled with each other, the components may then mechanically and electrically coupled with the housing 200 to provide for electrical power to be delivered to the motor(s) of the locking assembly 600 and the valve assembly 500. Information regarding the flow rate through the metering assembly 400 may be calculated based upon sensor data obtained from the metering assembly 400. In addition, various data from other sensors and security features within the regulator assembly 300, the metering assembly 400, the valve assembly 500, the locking assembly 600, and the housing 200 can be identified, processed, recorded, stored, and/or output or communicated to other components or a central server.

Once the regulator assembly 300, the metering assembly 400, the valve assembly 500, the locking assembly 600, and the housing are mechanically and electronically coupled with each other, the lower enclosure 205, top cover 210, and lid 215 may be installed about the device 100 components. The engagement feature 235 may then be coupled to the proximal end 345 of the regulator key shaft 315.

### Use

The disclosed device 100 may be useful in metering, dispensing, and regulating flow of a fluid. In some embodiments, the device 100 may be coupled to a fluid supply (storage tank or cylinder) that contains an amount of the desired fluid. In some embodiments, the device 100 may be installed on an existing fluid supply, such as an LPG tank, so that the regulator assembly 300 couples to the LPG tank outlet. In various embodiments, the storage tank may be a standard design, or its design may be modified to mate securedly with the device. In most embodiments, an authorized technician, supplier, or distributor may install the device 100 to the LPG tank and securedly connect the device to the fluid supply. The technician may then activate the locking mechanism so that the device is locked to the supply, and cannot be removed by an unauthorized person.

In some embodiments, the technician may use a communications device to transmit a signal to the device 100 such that the locking assembly 600 is unlocked and the regulator key shaft 315 may be positioned in the disconnected position to prevent any fluid from undesirably flowing through the device 100 until the consumer desires it. This step may involve sending an electrical or wireless signal to the device 100, which may then activate the motor on the locking assembly 600 to move the locking shaft 605 to the unlocked position. An unlocked device may be installed on the supply. After positioning the unlocked device on the supply, the authorized person may engage the engagement mechanism, securedly connecting the device to the supply. In some embodiments, this may be performed remotely and/or may be automated—such as where the engagement shaft may be motor driven. After the engagement shaft has been rotated to the engaged position (“OFF” as shown in FIG. 1), the device 100 may be in fluid communication the fluid contained in the fluid supply. The technician may again send a signal to the device 100 that causes the motor of the locking assembly 600 to be moved to the locked position. This step helps prevent the disconnection and removal of the device 100 from the fluid supply. This may help prevent a tank owner from having the tank stolen or the valve manipulated so that the fluid in the tank is not discharged without the proper payment to the distributor, supplier or tank owner.

After the device 100 is installed and locked to the supply tank, a consumer may use a payment system to pay for an amount of fluid. In some embodiments, the payment may be made via wireless communications with a central server and to the tank owner, supplier, distributor, or other third party. Upon confirmation of payment receipt, a signal may be sent authorizing the device 100 to open the valve assembly 500, and begin measuring the fluid flowing through the metering assembly. Authorization of the device to dispense an amount of fluid may be completed electronically via a touchpad on the device (where the consumer may enter a code received from the central server or other authorized distributor of codes) or wirelessly through the device's communications module. Fluid with flow through the device 100, provided that the regulator key shaft 315 is in the User On position. In this aspect, the consumer may keep the regulator key shaft in the User Off position, until fluid is needed by the consumer. In many embodiments, a user may choose to turn the device on or off, thereby controlling how and when to use the purchased fluid.

If the regulator key shaft is in the User On position, but the pre-purchased amount of fluid has been dispensed by the device, or if a sensor has triggered the device to shut down, the motor of the valve assembly may be in the closed position preventing fluid flow through the assembly 500. The device may also issue a notification in the form of an audio signal or message displayed on the electronic screen informing the user that the valve assembly is in the off position due to lack of credit or security shut down. This may prompt the user to purchase more fluid or more credit for fluid, and/or send a signal to the central server that the device may require attention by technician or other an authorized person. When the consumer completes a transaction to purchase more fluid or fluid credit, another signal may be sent to the device 100 and the valve may be opened to allow fluid to once again flow from the fluid supply and through the device 100.

In the event that a security feature of the device 100 is activated, a signal may be sent to the valve of the valve assembly to move to the closed position and prevent fluid flow through the device 100. In addition, a signal may be sent to the tank owner, supplier or distributor that a security feature was engaged. In addition, a signal may be sent to a data log created and maintained by the device 100 so that the event may be reviewed during the next tank exchange or maintenance event.

In some embodiments, the device 100 may be controlled from a central server remote from the device and may go into a “safe” mode, locking down in the case of tampering, leaking (fluid flow when the valve assembly is closed or regulator assembly is closed) or if it cannot contact the server with a given time.

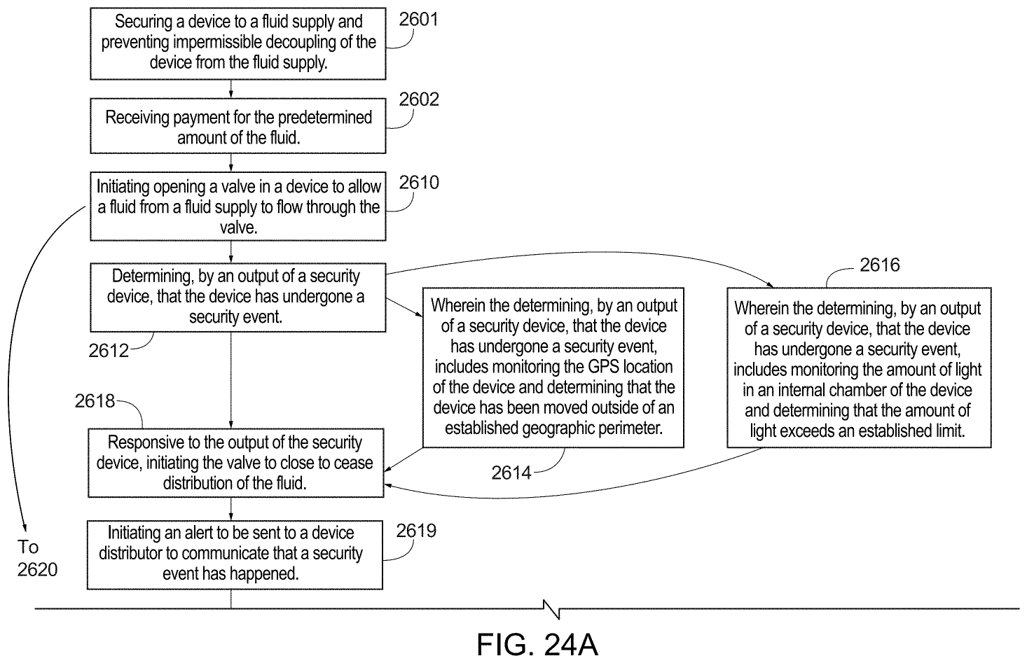

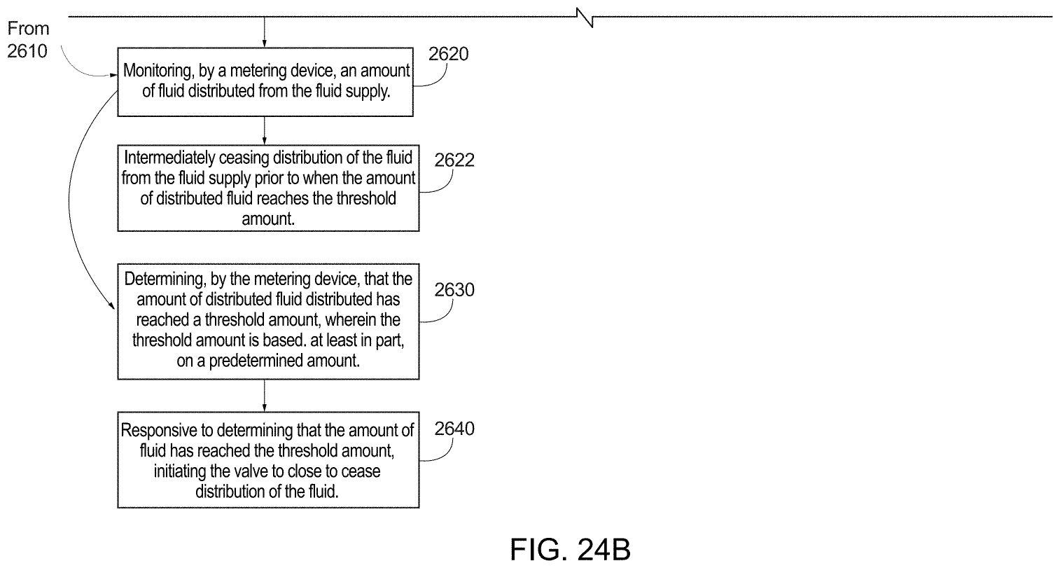

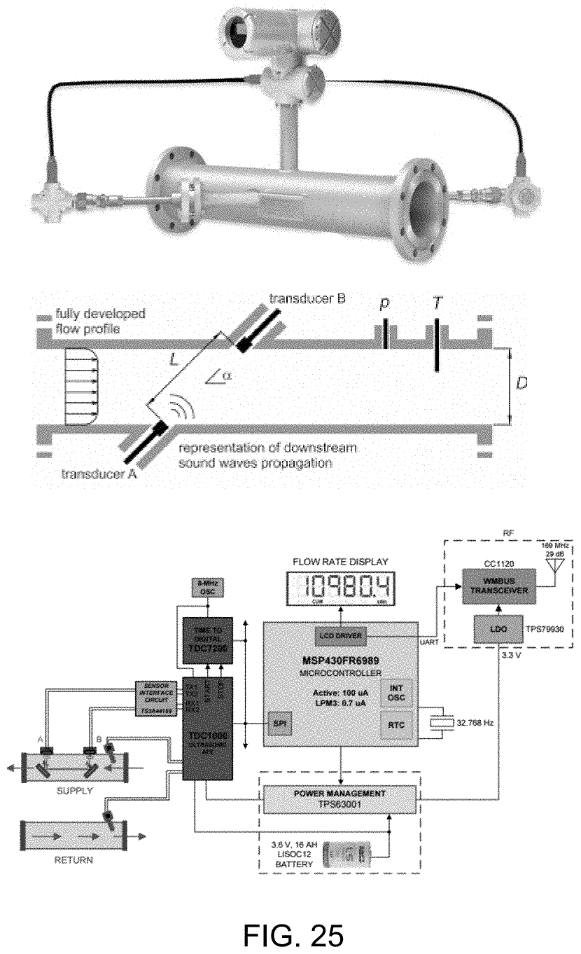

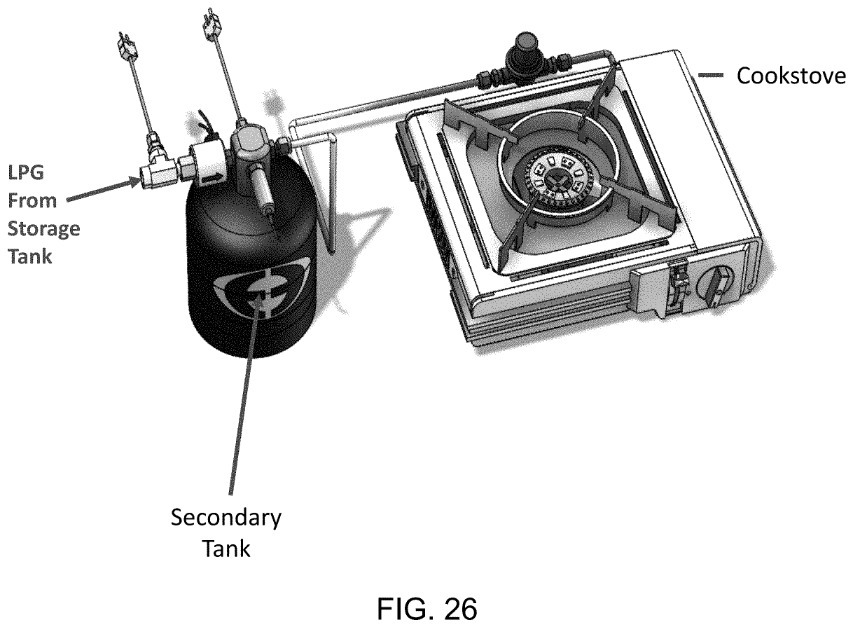

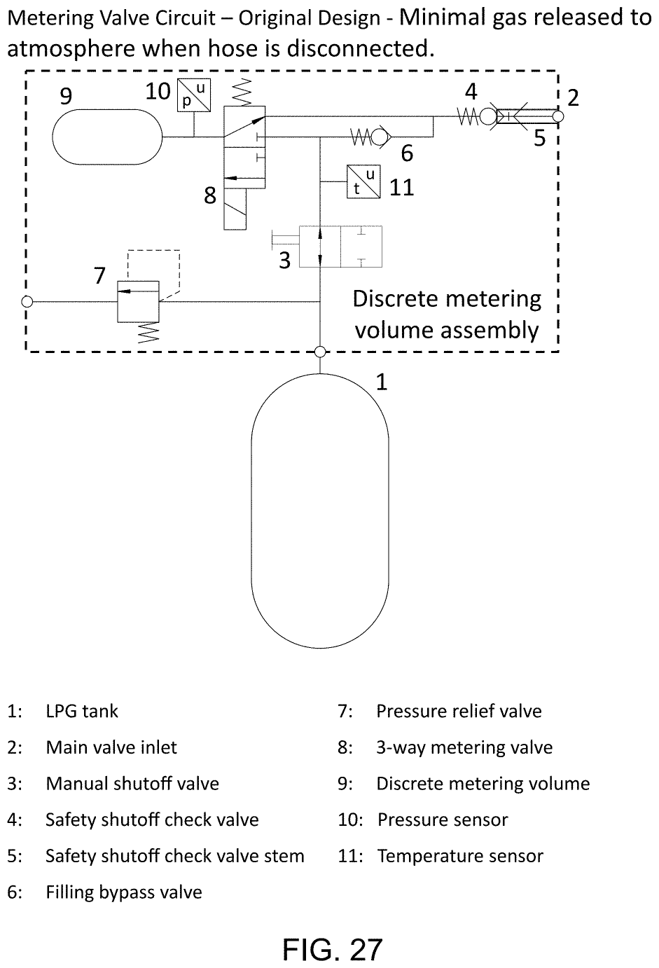

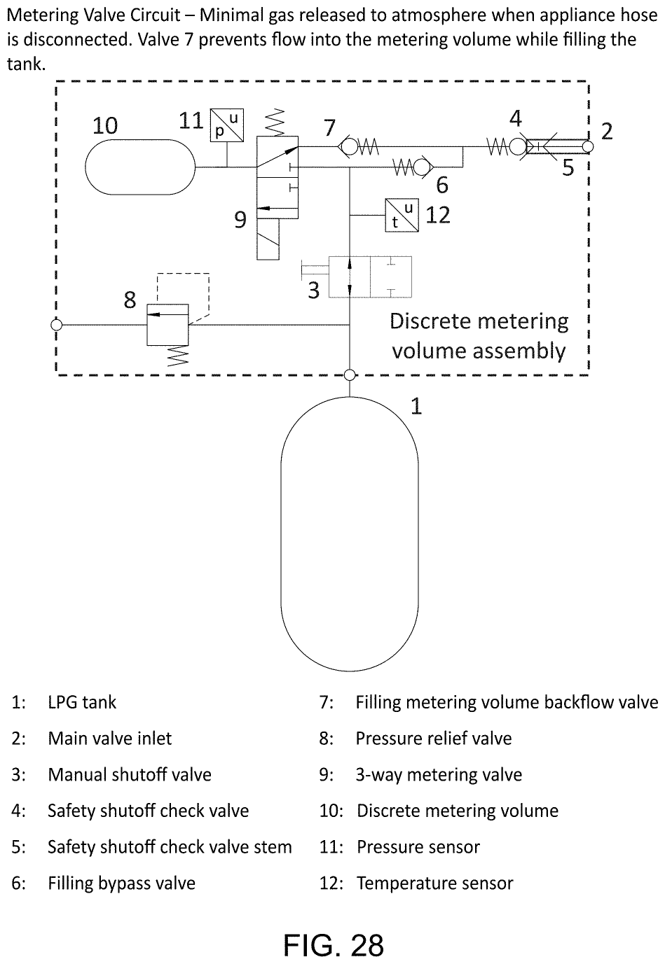

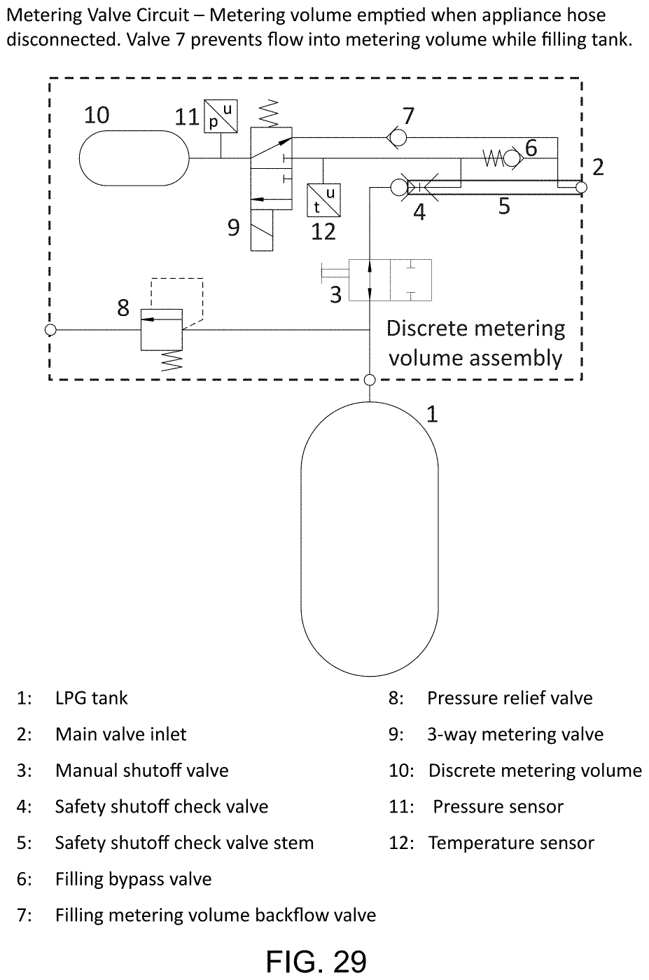

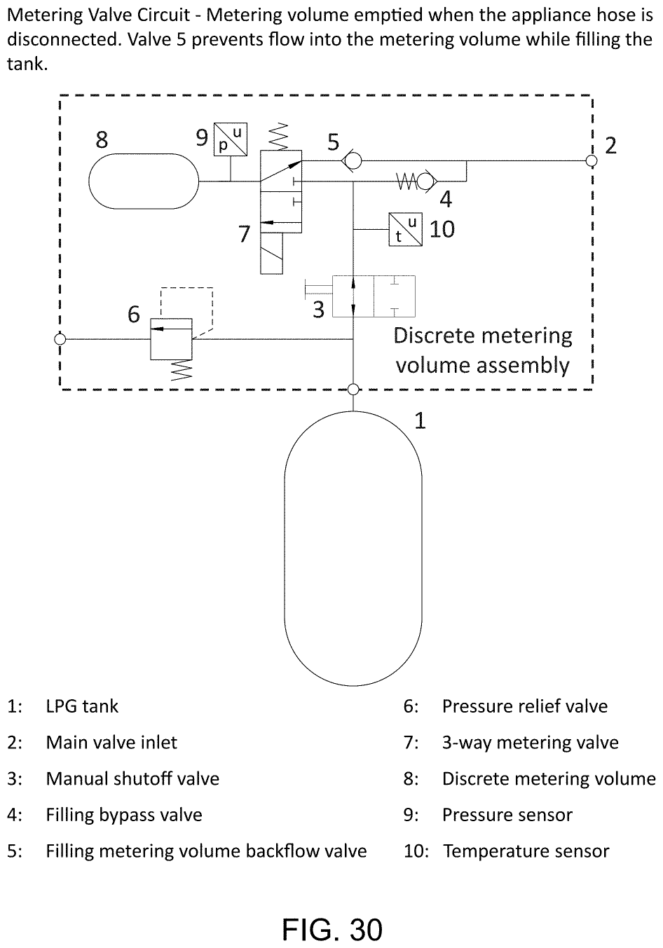

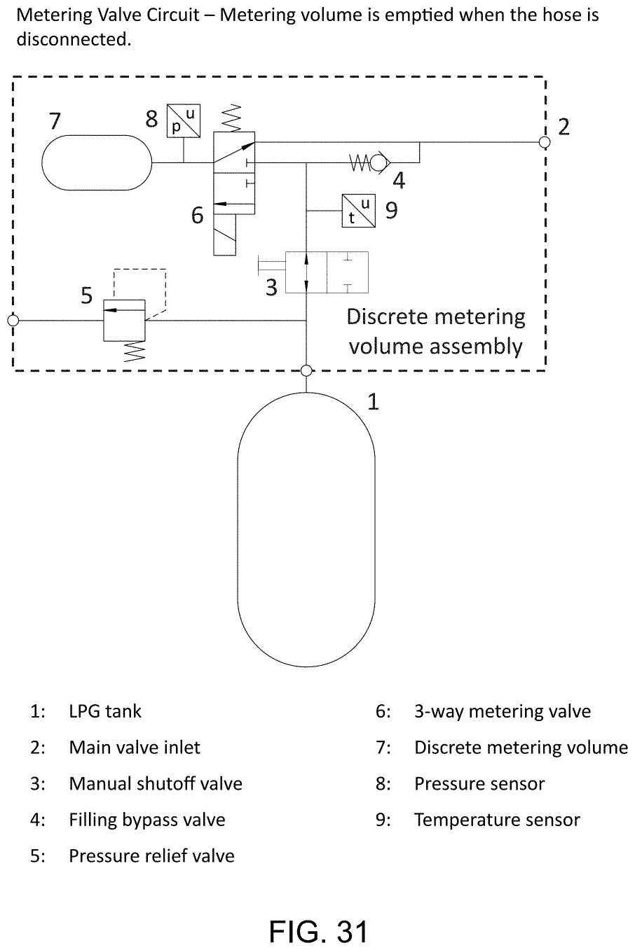

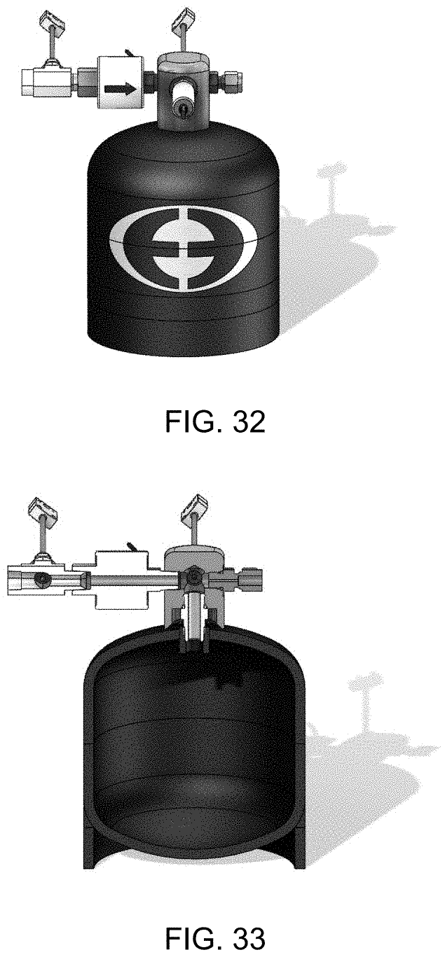

FIG. 24 is a flowchart illustrating a method of fluid distribution, in accordance with an embodiment of the present disclosure. In some embodiments, the method 2600 of distributing a fluid may include step 2610 of initiating opening a valve in a device to allow a fluid from a fluid supply to flow through the valve. After step 2610, a step 2620 may include monitoring, by a metering device, an amount of fluid distributed from the fluid supply. After step 2620, a step 2630 may include determining, by the metering device, that the amount of distributed fluid distributed has reached a threshold amount, wherein the threshold amount is based, at least in part, on a predetermined amount. After step 2630, a step 2640 may include responsive to determining that the amount of fluid has reached the threshold amount, initiating the valve to close to cease distribution of the fluid.

In some embodiments, step 2620 of monitoring, by a metering device, an amount of fluid distributed from the fluid supply, may directly follow step 2610 of initiating opening a valve in a device to allow a fluid from a fluid supply to flow through the valve.

In some embodiments, the method 2600 may further include step 2622 including intermediately ceasing distribution of the fluid from the fluid supply prior to when the amount of distributed fluid reaches the threshold amount.

In some embodiments, the method 2600 may also include step 2601 including securing a device to a fluid supply and preventing impermissible decoupling of the device from the fluid supply. The method 2600 may also include step 2602 including receiving payment for the predetermined amount of the fluid. The method 2600 may also include step 2612 including determining, by an output of a security device, that the device has undergone a security event. Step 2612 may further include step 2614 including monitoring the GPS location of the device and determining that the device has been moved outside of an established geographic perimeter. Step 2612 may further include step 2616 monitoring the amount of light in an internal chamber of the device and determining that the amount of light exceeds an established limit. The method 2600 may further include step 2618 including responsive to the output of the security device, initiating the valve to close to cease distribution of the fluid. The method may further include step 2619 including initiating an alert to be sent to a device distributor to communicate that a security event has happened.

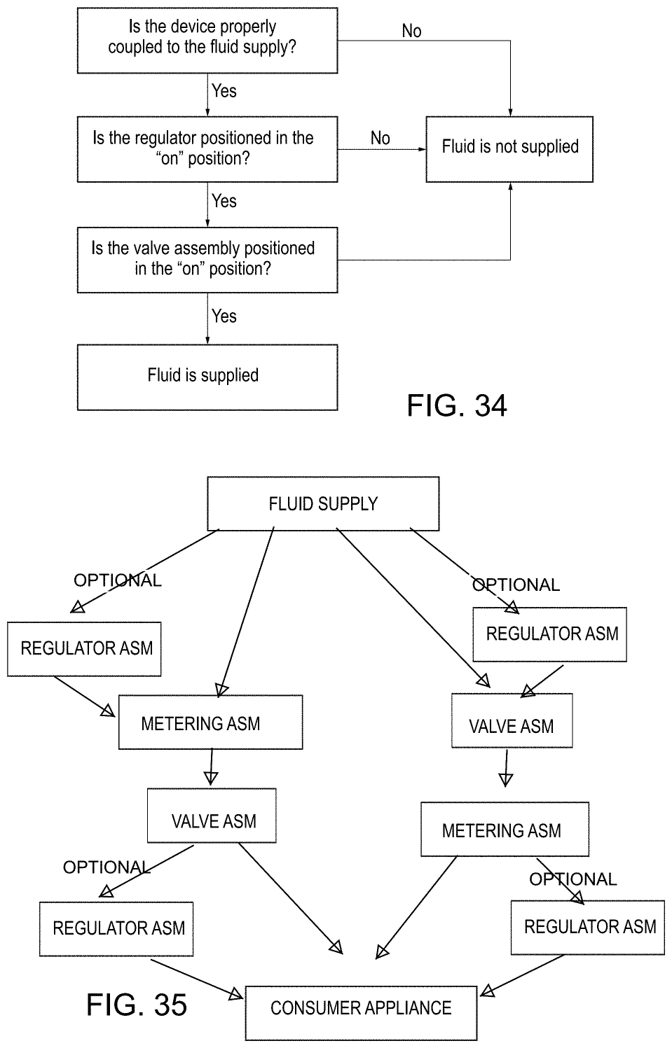

FIG. 34 is a decision chart for a fluid flow through a device. FIG. 34 includes if the device is properly coupled to the fluid supply, if the regulator positioned in the “on” position, and if the valve assembly in the “on” position. If all of these values are “Yes,” then fluid is supplied. If any of the values are “No,” then the fluid is not supplied.

In use a technician may obtain a device 100 with the locking assembly in the unlocked position and the regulator in the disconnect position. A technician may then physically place the device onto a fluid supply filled with fluid, such as a tank. At this point, the device is not physically or fluidly coupled to the fluid supply. The technician may then rotate the engagement feature to turn the regulator assembly from the disconnect position to the User Off position. At this point, a feature of the regulator engages with a feature of the fluid supply so that the device and the fluid supply are physically coupled together, but not fluidly coupled. The technician may then send a signal to the device to cause the locking assembly to move into the locked position. This signal may be sent via a hard wire, wireless, Bluetooth, radio connection or other method. At this point, the device is physically coupled and locked to the fluid supply, but not fluidly connected. The technician may leave the device with the user at this point, because the user will be unable to separate the device from the fluid supply. The technician or user may then rotate the engagement feature to turn the regulator assembly to the User On position. At this point, the device is physically coupled and locked to the fluid supply, and fluidly connected to the device. Fluid will not flow through the device and to a consumer appliance unless the valve assembly is in the On position, creating a fluid pathway between the fluid supply and the consumer appliance.

In some embodiments, the user pays for fluid or fluid credits that may be exchanged for fluid. The payment may be made directly to the device, directly to a distributor or provider who will then log the payment in a system that may electronically communicates with the device, or remotely to a distributor or provider via a payment system, wherein the payment system information may be communicated to the device. In some embodiments, the device may be equipped with a credit card reader or information input device, so that a user may input their payment information, be it made from a credit card, mobile money, gift card, checking account, payment port linked with money transfers, etc. Upon registration of the payment, the system used to manage the device may approve the opening of the valve assembly. Wherein the payment is made via an input feature of the device, the receivers, processing and storage devices included in the device, such as the CPU, memory, motherboard, etc., may transmit a signal to the valve assembly to open. Wherein the payment system may be separate from the device, this payment approval may be in the form of an electronic signal sent wirelessly to the device and received by a receiver, processed by a processing components such as CPU, and another signal may be sent or transmitted to the corresponding electronic systems that may include CPU, BUS, or CAN BUS systems and processors to effect the opening of the valve. The payment approval may be in the form of an electronic signal sent via a hard wire connected to the device. The payment approval may be in the form of an alphanumeric code provided to the consumer that the consumer then physically types into the device 100 or types into an electronic device that is connected to the device 100. The payment approval may be sent to the customer mobile phone and then transferred to the device 100 via a Bluetooth connection. When the payment is registered the device, the device may process the registration to then electrically communicate to the valve assembly to open.

The payment may establish a volume or mass of fluid (a predetermined amount) that the device may discharge. The device may then proceed to allow the fluid to flow from the fluid supply, through the device, and into a consumer appliance. The device may then process the signals and data to convert a volumetric consumption rate into a mass flow rate of the flow of the fluid through the metering assembly. The metering assembly may send intermittent or continuous signals to the CPU and/or associated electronic systems of the device to calculate and monitor the amount of fluid that is dispersed from the fluid supply as measured by the metering assembly. The calculation of fluid disbursement may include using data from sensors in the device that include static and dynamic environmental conditions, such as temperature, barometric pressure, humidity, pollution levels, etc. and/or changes therein as well as data from sensors measuring details about the fluid supply, such as measuring the temperature and composition of the fluid within the fluid supply and/or changes therein, potential contamination of the fluid within the fluid supply or the device, backpressure associated with the fluid coupling to the consumer appliance. Once the device has registered that a predetermined amount of fluid has been dispersed, the device may be configured to send a signal to the valve assembly to close to stop the flow of fluid through the meter. When the valve is closed, there is still fluid within the device because the valve is positioned downstream of the regulator assembly and the metering assembly. In some embodiments, where the amount of fluid supplied is nearing the predetermined amount, the device may be configured to send a signal to notify the user. The notifications may be in the form of a message displayed or emitted from the device, a text message sent to a phone or mobile device, an email, a notification within a mobile application, a status check or message within an online forum or account management tool, etc.

In addition, sensors may be included on the regulator assembly and valve assembly to determine the position of the components of the assembly and compare that data with status values of other parts of the device. For example, if the valve assembly is closed, and the regulator is in the user off position, yet the metering assembly is still measuring a fluid flow, the device may be configured to send a signal to a distributor, supplier, and user to alert them of a potential error. The signal may be displayed on the screen of the device or communicated to the user via a notification system, which may include a mobile app, email subscription, mailed notifications, phone calls, text message, or other form of communication. In some embodiments, this may also include a maintenance order to be placed with a service provider. In some embodiments, this fault may trigger a data log to be recorded to establish the amount of fluid dispersed before the fault happened, so that the consumer may not have to pay or be responsible for a malfunctioning device.

In some embodiments, sensors may be used to measure and calculate the amount of fluid within the fluid supply. Information from these sensors and associated calculations may then be automatically transmitted, push transmitted, or transmitted on a periodic basis to the user via the display screen, or via notifications from a mobile app, emails, etc. This information may also be sent to a distributor or supplier to notify them if the fluid supply is low (meaning the remaining fluid within the fluid supply is below a predetermined level). This information may also be used to transmit a message that the fluid supply needs refilling or replacing the fluid supply with another fluid supply that has a full volume.

In some embodiments, the device, when initially connected to the fluid supply and in the User Off position, may have a non-supplied fluid mixture within the regulator assembly and associated fluid connections up to the valve assembly. In some embodiments, the metering device may be able to differentiate between the non-supplied fluid and the supplied fluid such that the flow of non-supplied through the metering assembly would not be attributed to the consumer. Meaning, the flow through the metering device would be measurably different based upon the parameters of the non-supplied fluid such that the device may calculate when the supplied fluid from the fluid supply actually reaches the metering assembly such that the consumer should have to pay for the fluid. Such parameters may include density, temperature, condensation, humidity, barometric pressure, pollutant level, phase change, and other parameters that may be different between the supplied fluid and the non-supplied fluid.

In some embodiments, the device may come “pre-charged” such that the desired fluid is already within the fluid pipeline between the inlet of the regulator assembly and the outlet of the valve assembly.

In some embodiments, there may be a non-fluid mixture in a fluid pipeline between the outlet of the valve assembly and the inlet of the consumer appliance.

In some embodiments, the device may be operated without an interaction of a server, such that payment and distribution of the fluid is managed within the device itself. This embodiment may make it harder to monitor the fluid level and schedule maintenance and refills, but the device could be configured to push notifications such as emails, texts or various alerts to a designated external system (wherein the external system may or may not be configured to send information back to the device). In some embodiments, the device send and receive information to external system to help manage the device. In some embodiments, the device sends the information via radio transmission, remote data storage, a SIM card, a hard-wired connection, a wireless connection such as for example via Bluetooth, Wi-Fi, ZigBee, Z-wave, cellular network, 2G, 3G, 4G, infrared, LAN, WLAN, GSM, GAN, wireless PAN, wireless LAN, MANET, WiMAX, wireless WAN, wireless MAN, or other method, or other communication network

In some embodiments, the device 100 may be used with an LPG distribution system. In other embodiments, aspects described herein of the LPG distribution system may also be used to in other fluid distribution systems, such as water, purified water, LNG, gasoline, and other fluids.

LPG provides clean and convenient energy to people. LPG systems may be particularly useful in the developing world where infrastructure for power delivery is still improving. LPG systems typically include a tank in which LPG is stored. The tank may be connected to one or more appliances, such as stoves, and a valve opened to allow gas to flow from the LPG tank to the appliance. Many traditional LPG systems use a tank exchange program. A consumer rents or purchases a full tank from an LPG provider. The consumer then uses the LPG in the tank until the tank is empty and then the consumer can return and/or exchange the empty tank for a new, full tank. LPG is also used in the developed world, for example in rural environments where large LPG tanks may supply gas for many household uses. In these circumstances pre paying to fill a large tank may be challenging for the customer and they may desire to pay in smaller increments either pre paying for smaller amounts of LPG or being billed on a monthly basis for actual fuel used, similar to how CNG billing works in urban markets. LPG may be used in a variety of contexts, such as heating and cooking, among others. Also across the world there is a desire to increase CNG network penetration. Many utilities struggle however to get paid consistently by their customers and have to endure the costs of sending out staff to shut off connection for delinquent customers. In many embodiments, such as where the fluid is a fuel, such as a gas, the CNG (compressed natural gas) may be sold by volume and may also be metered based on volume, while LPG (liquefied petroleum gas) may be sold by mass and may be metered based on mass. In many embodiments, the metering assembly may be calibrated, or the processing unit may be configured to measure fluid based on volume and/or mass.

According to one embodiment, a method of distributing LPG is described. The method comprises receiving payment for a predetermined amount of LPG, transmitting an instruction to a valve to distribute LPG, monitoring, by a metering device, an amount of LPG distributed determining, by the metering device, that the amount of distributed LPG has reached a threshold amount, wherein the threshold amount is based, at least in part, on the predetermined amount, and responsive to determining that the amount of distributed LPG has reached the threshold amount, transmitting an instruction to the valve to cease distribution of the liquefied petroleum gas.

According to one embodiment, a method of distributing LPG is described. The method comprises, monitoring, by a metering device, an amount of LPG distributed determining, by the metering device, that the amount of distributed LPG, over a given time span and billing the customer post pay for the amount of fuel used over the time span, and in the event that the customer does not pay the bill in a timely manner, transmitting an instruction to the valve to cease distribution of the liquefied petroleum gas.

According to one embodiment, a method of distributing LPG is described. The method comprises, monitoring, by a metering device, an amount of LPG distributed determining, by the metering device, that the amount of distributed LPG, over a given time span and billing the customer post pay for the amount of fuel used over the time span.

According to one embodiment, a method of distributing CNG is described. The method comprises receiving payment for a predetermined amount of CNG, transmitting an instruction to a valve to distribute CNG, monitoring, by a metering device, an amount of CNG distributed determining, by the metering device, that the amount of distributed CNG has reached a threshold amount, wherein the threshold amount is based, at least in part, on the predetermined amount, and responsive to determining that the amount of distributed CNG has reached the threshold amount, transmitting an instruction to the valve to cease distribution of the liquefied petroleum gas.

According to one embodiment, a method of distributing CNG is described. The method comprises, monitoring, by a metering device, an amount of CNG distributed determining, by the metering device, that the amount of distributed CNG, over a given time span and billing the customer post pay for the amount of fuel used over the time span, and in the event that the customer does not pay the bill in a timely manner, transmitting an instruction to the valve to cease distribution of the liquefied petroleum gas.

According to one embodiment, a method of distributing CNG is described. The method comprises, monitoring, by a metering device, an amount of CNG distributed determining, by the metering device, that the amount of distributed CNG, over a given time span and billing the customer post pay for the amount of fuel used over the time span.

According to another embodiment, a system is described. The system comprises a tank configured to store a volume of LPG, a metering device, wherein the metering device measures an amount of LPG used by a consumer, and a valve, wherein the valve is configured to control flow of the LPG from the tank and to close responsive to the metering device measuring that a predetermined amount of LPG has been provided from the tank. The system may further comprise a location monitoring sub-system, wherein the location of the tank and metering device may be monitored and recorded.

According to yet another embodiment, a method is described. The method comprises receiving a payment for a predetermined amount of LPG, opening a valve to open to provide the predetermined amount of LPG, determining that an amount of distributed LPG has reached the predetermined amount, and closing the valve.

Embodiments disclosed herein may recognize several drawbacks from traditional LPG distribution system. First, there are limited distribution points for LPG tanks. Many consumers must travel many miles to find a distribution point at which they can exchange an empty tank for a full one. Second, there is a high upfront cost. Purchasing larger tanks reduces the cost per kilogram of LPG, but larger tanks are more expensive upfront. Therefore, while many consumers can afford to use LPG on a daily basis, the high upfront costs of the tank may prevent the consumers from entering the market to begin with. Third, many traditional LPG tanks do not provide accurate indications of when the LPG in the tank may run out. As a result, some consumers are reluctant to use LPG for fear that the gas will run out in the middle of cooking a meal or before the consumer can afford to refill the tank. Fourth, because LPG is typically purchased by the tank, customers do not want to return a tank that still contains LPG. However, it is often difficult to know exactly how much LPG is left in a tank and to properly align LPG needs with the expiration of the LPG in the tank. Embodiments disclosed herein provide methods and systems for pay-as-you-go LPG use that may address one or more of the above identified limitations of previous systems

In some embodiments, the main LPG tank may be a primary reservoir for LPG in the system. The main LPG tank may generally be made of any suitable material for holding LPG, such as stainless steel or carbon steel. The main LPG tank may be a permanently installed LPG tank or an exchangeable tank that can be removed and exchanged for a new tank. In some embodiments, the main LPG tank may be maintained by an LPG distribution company that may distribute, service, and otherwise maintain the LPG tank and system. In other embodiments, the main LPG tank may be maintained by a consumer. For example, the consumer may obtain a full, tamper-proof main LPG tank from a distributor with a security deposit, bring the main LPG tank to their home and connect the main LPG tank to the system. In most of these embodiments, the LPG tank has a smart valve and/or other metering devices (discussed above) fixedly attached to the tank. LPG may be used from the main LPG tank on a pay-as-you-go basis. In the pay-as-you-go system, the customer makes a payment for a predetermined amount of LPG, which is then distributed from the main LPG tank.

In some embodiments, the metering device measures the rate at which LPG is used from the main LPG tank and closes a valve once the purchased amount of LPG has been used. The metering device may generally be any type of metering device capable of monitoring the mass of LPG remaining in the main LPG tank and/or monitoring the amount of LPG being used. The metering device may be located in-line between the main LPG tank and the appliance. In one embodiment, the metering device estimates the gas volume in the main LPG tank by taking a known volume of gas out of the main LPG tank quickly and measuring the instantaneous drop in pressure. According to another embodiment, the metering device may measure the mass of LPG in the main LPG tank using capacitive liquid level measurement sensors. In yet another embodiment, the metering device 106 may measure the liquid level in the main LPG tank using petroleum tank floats. In yet another embodiment, the metering device 106 may measure the liquid level in the main LPG tank using ultrasonic signals. In yet another embodiment, the metering device may measure the volume of gas in the main LPG tank using a Helmholtz resonator.

In yet another embodiment, the metering device may use discrete volume metering to premeasure an amount of LPG from the main LPG tank. For example, a volume of liquefied or gaseous petroleum may be allowed to flow into a discrete volume tank through a smart valve. The smart valve may be, for example, a solenoid valve that is configured to open and close responsive to instructions based on an amount of LPG that is purchased by a consumer. The smart valve may be coupled to an electronic controller, which may have wireless connectivity capabilities (e.g., through Bluetooth, a SIM card, or other communication network). The controller may control the opening and closing of the valve based, in part, on instructions from a mobile device or a remote server. The temperature of the gas may be measured with temperature sensors and the pressure may be measured with a pressure transducer. Based on the pressure and the temperature of the gas in the discrete volume tank, the composition and mass of the gas may be determined, for example by reference to a chart or look up table relating gas composition to vapor pressure and temperature. Once the total mass in the discrete volume tank reaches the capacity of the discrete volume tank or some other threshold amount, a smart valve, such as a solenoid valve, may disconnect the discrete volume tank from the main LPG tank and the consumer may use the gas from the discrete volume tank to power the appliance. Once the amount of fuel in the discrete volume tank drops to a threshold amount, additional LPG is transferred to the discrete volume tank (in other embodiments, liquid petroleum is transferred to the discrete volume tank). The threshold may be based, for example, on a vapor pressure needed to maintain uninterrupted usage of the appliance. For example, an appliance may use gas at vapor pressure of about 0.1 to 60 psi (an operating vapor pressure), while an LPG tank may have a pressure of about 100 to 200 psi, and the vapor pressure in the discrete volume tank may be between about 0.1 and 200 psi. Once the vapor pressure in the discrete volume tank drops to a threshold amount at or above the operating vapor pressure of the appliance, the discrete volume tank may be refilled by activating the smart valve. The refilling of the discrete volume tank may be monitored and each refill iteration may be counted. Based on the number of refills and the known volume of each usage or refill, the total amount of LPG may be monitored and when the amount used nears the amount purchased by the consumer, a prompt for an additional purchase may be provided to consumer. Discrete volume metering may be used in conjunction with or instead of various other types of metering.

In yet another embodiment, the metering device may use ultrasonic metering to monitor the flow rate of LPG gas from the main LPG tank. An ultrasonic flow meter may determine the volumetric flow rate of LPG to the appliance. An ultrasonic flow meter determines the flow rate of the LPG by measuring the time of flight of a phonon through the gas both with the flow of the LPG and against the flow of the LPG. Based on the difference between the two times of flight, the distance between the transmitter and the receiver, and cross-sectional area of the meter, and the speed of sound in the fluid, the volumetric flow rate of the LPG may be calculated. Ultrasonic metering may be used in conjunction with, or instead of other types of metering.

In some embodiments, the payment system may facilitate, receive, and/or confirm payment by a consumer for a specified amount of LPG. The payment system may be coupled to the metering device. In various embodiments, the payment system may take a variety of forms. In one embodiment, the payment system may be a computing system having one or more processors. The payment system may be coupled to a communication network. The communication network may generally be any type of communication network. For example, the communication network may be a local area network or a wide area network (e.g., the Internet). The payment system may be configured to communicate with one or more mobile devices over the network or other communication means (e.g., a short range communication means, such as Bluetooth®). For example, a consumer may provide payment information through a mobile phone connected to a cellular network or a Wi-Fi network. The mobile phone may communicate with the payment system over the same or a different network and confirm that the consumer has paid. The payment system may then communicate with the metering system to provide a paid-for amount of LPG from the main LPG tank to the appliance.

In another embodiment, the payment system may include an interface for direct interaction between a consumer and the payment system. For example, the payment system may include a keypad for entering a credit card number or an authorization code that indicates the consumer has purchased a specified amount of LPG. In some embodiments, the keypad may be implemented as a backup and/or alternative system to the communication network discussed above. For example, in the event that the communication system becomes unavailable, the keypad may be used by the consumer to purchase additional LPG. In such an embodiment, a consumer may provide payment information through a mobile phone or other device coupled to a network, or a scratch-card purchased from a vendor. The payment information may be confirmed, for example, by a remote server or other third party. In response, the remote server may provide a validation code to the consumer through a text message, a webpage, a phone call, or other communication means. The consumer may then enter the validation code into the payment system via the keypad. The payment system may verify the validation code against a database of validation codes and in response to verifying the validation code, the payment system may communicate with the metering device to provide a paid-for amount of LPG from the main LPG tank to the appliance.

In some examples, the device may include an appliance regulator to measure and/or regulate a pressure of LPG provided to the appliance. The appliance regulator may include, for example, a pressure transducer and be calibrated with the appliance. In various embodiments, the appliance regulator may communicate with the metering device to ensure that the pressure of LPG provided to the appliance does not drop below a threshold amount. For example, the appliance regulator may determine that the LPG pressure provided by the discrete volume tank has dropped below a threshold amount and, in response, trigger the smart valve to refill the discrete volume tank from the LPG main tank. In some embodiments, the appliance regulator may be located before, after, or incorporated into the metering device. For example, in embodiments implemented with an ultrasonic metering device, the appliance regulator may be located between the main LPG tank and the metering device. Such a placement may improve the ability of the appliance regulator to accurately regulate the flow of LPG to the appliance, as well as improving the ability of the metering device to measure gas flow.

In some embodiments, the appliance may generally be any type of machine or device that can be powered by LPG. For example, the appliance may be a gas powered stovetop for use in cooking, a heater, a barbeque, a water heater, a refrigerator, a clothes dryer, an oven, or a combination thereof.

In some embodiments, the location monitor may be any type of machine or device that may provide information on the location of the tank, metering device, smart valve, etc. In some embodiments, the location monitor may be a satellite navigation receiver, for example a GPS receiver. In other embodiments, the location may be determined by the location of cellular towers that the device connects to. In other embodiments, the location monitor may include a radio-frequency transmitter unit that may send a signal to a receiving unit. In these embodiments, the receiving unit may be connected to a phone, cellular network, internet, or other network for sending information the distribution company. In some embodiments, the location monitor may provide the distribution company information on the location of the tank, metering device, valve, etc. In some embodiments, the location monitor may alert the consumer or the distribution company if the tank, metering device, valve, etc. has been re-located. In many embodiments, the location monitor may also issue an alert if the location monitor is separated from the tank, metering device, valve etc. The location device may aid in preventing the loss, transfer, or mis-use of the disclosed tank, metering device, etc.

In some embodiments, the pay as you go option may remove the upfront cost barrier that consumers face. To implement the pay as you go model, the smart valve may accurately measure how much LPG is released from the tank. As it does this it can also monitor how much fuel is remaining in the tank. This information can be clearly displayed to the consumer allowing them to manage how much fuel they are using over time to meet their budget needs and also gives them a clear indication of when their tank is running low so they can plan ahead to have it refilled or exchanged without ever running out. Since consumers only pay for the fuel that they use out of the tank they also need not worry about returning the tank early with some LPG left in the tank as they are not charged for that fuel. An additional potential value to the consumer may include in home refilling or an exchange program. By monitoring fuel usage in a home either remotely via a SIM enabled system or by tracking how many codes a customer has input into the valve a central distribution management system would know when the tank is getting low and notify the consumer to set up a time to exchange or refill the tank. Doing this may improve consumer experience. In addition, this ability to monitor the volume of LPG in a tank, and notify the consumer and/or distribution company may be useful in both developing and developed countries.

In some embodiments, a method of LPG distribution, may include the LPG distribution system prompts a consumer for payment. In various embodiments, the prompt may be provided in one of a variety of ways. For example, the consumer may navigate to a webpage using a computer or smartphone, and the webpage may prompt the consumer to enter their payment information, such as a credit card number. In another embodiment, a consumer may dial in to a call center which then prompts them, through either a call center operator or through an automated payment system, to enter their payment information orally or through a telephone key pad. In yet another embodiment, a consumer may be prompted for payment through a mobile application. In still another embodiment, a consumer may be prompted for payment through an in person interaction, such as through a local retailer. In some embodiments, a consumer may purchase a scratch card from a vendor, wherein the scratch card includes a verification, activation, or payment code that is accessible after payment to the vendor. In many embodiments, scratch cards may be issued in various denominations, which may activate the system to dispense various amounts of petroleum gas.

In some embodiments, the LPG distribution system receives payment from a consumer. For example, the consumer may provide payment through the same medium through which the prompt for payment was provided in an earlier operation. Payment may be made in any manner, such as credit card, mobile application, wire transfer, electronic transfer of funds, check, cash payment, gift card, etc.

In some embodiments, the LPG distribution system verifies the payment. Payment verification may be conducted remotely or by the payment system. For example, a remote server may verify that the consumer has tendered payment for a specified amount of LPG by verifying a credit card number. Alternatively, verification may be conducted by the payment system itself. For example, in response to tendering payment, the consumer may be provided with a verification code. The verification code may be provided via text message, phone call, email, scratch card, or any other mode of communication. To verify that payment has been made, the consumer may manually enter the verification code into the payment system via a key pad.

In some embodiments, the LPG distribution system permits LPG usage. The LPG distribution system may permit LPG usage by opening the smart valve in response to the entry of a valid verification code may trigger the metering device to open the smart valve and to allow the purchased amount of LPG to flow into the discrete volume tank and/or to the appliance. In some embodiments, the smart valve may remain open until the purchased amount of LPG is used by the consumer.

In embodiments where verification occurs remotely, a remote server may verify that payment has been received and provide an instruction to the metering device of the LPG distribution system to provide a specified amount of LPG for use by the appliance. For example, the remote server may communicate via a computer or cellular network with the LPG distribution system to provide a specific instruction regarding an amount of LPG purchased.

In some embodiments, the LPG distribution system monitors LPG usage. LPG usage may be monitored, for example, by the metering device. For example, the metering device may monitor an amount of LPG stored in the discrete volume tank. Alternatively, the metering device may use ultrasonic metering to measure the flow rate of the LPG to the appliance.

In some embodiments, the LPG distribution system determines whether the LPG usage has reached its limit. In embodiments implemented with a discrete volume tank, the LPG distribution system may monitor the amount of LPG in the discrete volume tank and when the level of LPG in the tank reaches a certain threshold or is empty, the LPG distribution system may determine that the LPG usage has reached its limit. Alternatively, in embodiments where the amount of LPG used is actively monitored, such as through ultrasonic flow monitoring, the metering device may compare the measured amount of LPG used with the purchased amount to determine whether the LPG usage has reached its limit. If the LPG distribution system determines that the LPG usage has not reached its limit, then the LPG distribution system returns to monitoring LPG usage in operation.

In some embodiments, if the LPG distribution system determines that the LPG usage has reached its limit then the LPG distribution system determines whether a level of LPG in the main LPG tank has dropped below a threshold amount. The threshold amount may be set by a tank distributor and may be indicative that the main LPG may be nearly empty and should be exchanged or a full tank or refilled. If the LPG distribution system determines that the level of LPG in the main LPG tank has not dropped below a threshold amount then the LPG distribution system may prompt the consumer for payment in operation.

In some embodiments, if the LPG distribution system determines that the level of LPG in the main LPG tank has dropped below a threshold amount, then the LPG distribution system transmits an alert in operation. The alert may be a visual and/or auditory alert and may be displayed on the LPG distribution system or transmitted to a distributer over a communication network. Alternatively or in addition, the alert may be provided via text message, email, phone call, or any other type of communication. The alert may communicate that the main LPG tank may be nearly empty and may need to be refilled or exchanged in order to continue using LPG as a power source.

Disclosed herein are devices that provide for accurate and precise measuring of fluid dispensed from a storage tank. In some embodiments, the disclosed device is or includes a valve that is able to regulate access to a fluid storage tank (a “smart valve”). In some embodiments, the valve includes a secondary tank and/or a fluid flow monitoring system. The secondary tank may include a plurality of sensors for measuring pressure and temperature of a fluid within the secondary tank. In some embodiments, the valve and tank further include a processing unit for calculating the composition and mass of fluid within the secondary tank, and regulator for opening and closing the valve. In some embodiments, a second valve may allow a fluid, such as a gas mixture, to flow from the secondary tank to a consumer appliance, such as a cookstove.

The smart valve may include at least one flow sensor for measuring the mass of fluid flowing from the storage tank. In in these embodiments, the flow sensor may be positioned upstream or downstream of the smart valve, and may be configured to measure the mass of fluid, such as a gas, flowing through a portion of the system. In many embodiments, the flow sensor measures flow rate and composition by electromagnetic waves, for example ultrasound.

The disclosed metering device and methods may include a secondary tank or reservoir. In many embodiments, the secondary tank or reservoir is of a known and defined volume, so that the processing unit is able to calculate the mass of fluid within the volume from the volume of the tank as well as the temperature and pressure of the fluid within the tank. In some embodiments, this feature may be useful when the fluid is a gas mixture, such as a combination of propane and butane and other components. In many embodiments, this may be referred to as discrete fuel volume metering. The secondary tank may any volume from a few cubic centimeters (cc) to several thousand cc. The tank may be manufactured from a variety of materials suitable for the storage of pressurized fuel, for example stainless steel or carbon steel with corrosion protection, etc.

Ultrasonic flow meters are able to accurately measure volumetric flow rates of gasses. In one embodiment wherein the fluid is a gas, the disclosed system may include an ultrasonic flow meter for monitoring the amount of gas flowing through a gas line. The flow meter may be positioned upstream or downstream of the disclosed smart valve. In many embodiments, an ultrasonic flow meter may determine velocity of the gas by measuring time of flight of a sound pulse between a transmitter and receiver. In these embodiments, the calculated time of flight may be calculated with, and against, the flow direction, and this calculation may help to reduce or cancel effects of speed of sound. In many embodiments, the volumetric flow rate is estimated using time of flight, the known distance between transmitter and receiver, and the meter's cross-sectional area. In some embodiments, other sensors may monitor the temperature and/or pressure of the gas. In many embodiments, the meters and sensors may be in electrical connection with at least one processing unit, which may be in electrical communication with a controller that may be used to open and close the smart valve. Some embodiments may use flow conditioning to minimize asymmetric flow/vortices within the measurement chamber.

All references disclosed herein, whether patent or non-patent, are hereby incorporated by reference as if each was included at its citation, in its entirety. In case of conflict between reference and specification, the present specification, including definitions, will control.

Although the present disclosure has been described with a certain degree of particularity, it is understood the disclosure has been made by way of example, and changes in detail or structure may be made without departing from the spirit of the disclosure as defined I the appended claims. Various embodiments described herein are presented for illustrative purposes only and are not meant to be limiting. Various components parts, operations, and/or method steps may be omitted or presented in a different configuration or order other than those particular embodiments described above without deviating from the scope of the disclosure as set forth in the attached claims.

What is claimed is:

1. A device comprising:
a housing with a security feature;
a metering assembly configured to measure a quantity of fluid distributed from a fluid supply;
a device outlet configured to fluidly couple the metering assembly to an apparatus;
a locking assembly configured to be coupled to the fluid supply; and
a controller electrically coupling the housing, metering assembly, and the locking assembly.

2. The device of claim 1, further comprising a receiver electrically coupled to the controller.

3. The device of claim 1 or 2, further comprising a regulator assembly fluidly coupled to the metering assembly, and wherein the regulator assembly configured to be fluidly coupled to a fluid supply and regulate a flow of a fluid distributed from the fluid supply.

4. The device of any of claims 1-3, further comprising a valve assembly fluidly coupled to the metering assembly, wherein the valve assembly
is configured to control a flow of the fluid through the device; and
is configured to be positioned in a valve open position responsive to a first signal, and in a valve closed position responsive to a second signal that is based upon a determination that a predetermined quantity of fluid has been distributed from the fluid supply.

5. The device of claim 4, wherein the valve assembly is configured to be positioned in the valve closed position responsive to a third signal that is based upon a status of the security feature of the housing.

6. The device of claim 5, wherein the security feature is selected from one or more of an optical sensor, an accelerometer, a motion detector, a barometer, a GPS module.

7. The device of any of claims 1-6, wherein
in a first position, the locking assembly is configured to securely couple the device to the fluid supply and prevent impermissible decoupling of the device from the fluid supply;
in a second position, the locking assembly is configured to allow the device to be permissively decoupled from the fluid supply; and
the position of the locking assembly is remotely controlled.

8. The device of any of claims 1-7, the housing further comprising a first section and a second section, wherein the first section includes an electronic display, a unit identifier, and a diagnostic interface configured to allow a data stream from the processor of the device to be electrically communicated to an external source, and the second section includes the security feature.

9. The device of claim 1-8, wherein the electronic display is configured to default to showing a first set of data to a consumer and is configured to show a second set of data when a technician executes an authentication procedure.

10. The device of any of claims 1-9, wherein the device comprises a power source selected from one or more of a battery, a power adaptor for connecting to an external power source, or a photovoltaic cell that provides electrical power to the device.

11. The device of claim 10, wherein the device is powered an external source by wall power.

12. The device of any of claims 1-11, wherein the housing comprises a diagnostic interface configured to charge a battery of the device when an external source is electrically connected to the device through the diagnostic interface.

13. The device of any of claims 1-12, wherein the metering assembly includes a fluidic oscillator.

14. The device of any of claims 4-5, wherein the valve assembly includes a plunger assembly coupled to a first motor.

15. The device of claim 14, wherein the first motor is configured to control a position of a plunger of the plunger assembly to move between the open position and the closed position.

16. The device of claim 7, the locking assembly further comprising a locking shaft coupled to a second motor, wherein the operation of the second motor moves the locking shaft in a linear motion between the second position and the first position.

17. The device of claim 7, wherein the locking shaft interacts with a regulator key shaft of the regulator assembly.

18. The device of claim 4, wherein the predetermined quantity of fluid distributed from the fluid supply is calculated based upon a cost of a volumetric unit of the fluid.

19. The device of claim 4, wherein the predetermined quantity of fluid distributed from the fluid supply is calculated based upon a cost of mass unit of the fluid.

20. A method of distributing a fluid comprising:
signaling a fluid metering device that an authorized payment has been received for a predetermined amount of fluid to be transferred through the device;
signaling a valve assembly in the device to open a fluid channel;
monitoring, by a metering device, an amount of fluid flowing through the device;
signaling the valve assembly to close when the predetermined amount of fluid has passed through the metering device; and thereby
distributing a fluid.

21. The method of claim 20, further comprising securing the device to a fluid supply to prevent unauthorized decoupling of the device from the fluid supply.

22. The method of any of claims 20-21, further comprising receiving payment from a user for the predetermined amount of the fluid.

23. The method of any of claims 20-22, wherein the device includes one or more sensors for monitoring light, movement, temperature, barometric pressure.

24. The method of any of claims 20-23, further comprising signaling the valve assembly to close in response to a signal generated by a security feature.

25. The method of claim 24, wherein the security feature is monitoring the device's location via GPS module.

26. The method of claim 24 or claim 25, wherein the security feature is monitoring light within the device.

27. The method of any of claims 24-26, wherein the security feature is generating a signal to the processing unit resulting in a signal being sent to a central server.

28. A remotely activated valve for dispensing a predetermined amount of liquid petroleum gas, comprising:
a valve;
a controller connected to the valve; and
metering device connected to the controller.

29. The valve of claim 28, wherein the metering device includes a secondary gas tank, and a plurality of sensors.

30. The valve of any of claims 28-29, wherein the metering device includes a gas flow meter, and a plurality of sensors.

31. The valve of any of claims 28-30, wherein the metering device is a fluidic oscillator.

32. A method for remotely activating a valve for dispensing a predetermined amount of liquid petroleum gas from a tank, comprising:
a user sending a request for dispensing a volume of gas from the tank;
a provider receiving a request for payment for the volume of gas;
the user sending the payment to the provider;
the provider authorizing a controller connected to the valve to dispense the gas;
the valve dispensing the gas; and
a metering device for measuring the dispensed gas.

33. The device of claim 1, wherein the security feature is an accelerometer.

34. The device of claim 1, wherein the security features is a strain gauge.

35. The device of claim 1, wherein the security feature is a location monitoring device.

37. A device comprising:
a housing with a security feature;
a metering assembly configured to measure a quantity of fluid distributed from a fluid supply;
a valve assembly fluidly coupled with the metering assembly, wherein the valve assembly is configured to control a flow of the fluid through the device;
a device outlet configured to fluidly couple the metering assembly and the valve assembly to an apparatus;
a locking assembly configured to be coupled to the fluid supply; and
a controller electrically coupling the housing, metering assembly, and the locking assembly.

38. The device of claim 37, wherein the valve assembly is positioned fluidly upstream of the metering assembly.

39. The device of claim 38, further comprising a regulator assembly fluidly coupled to and downstream of the metering assembly, and wherein the regulator assembly configured to be fluidly coupled to a fluid supply and regulate a flow of a fluid distributed from the fluid supply.

40. The device of claim 38, further comprising a regulator assembly fluidly coupled to and downstream of the valve assembly, and wherein the regulator assembly configured to be fluidly coupled to a fluid supply and regulate a flow of a fluid distributed from the fluid supply.

40. The device of claim 37, wherein the valve assembly is positioned fluidly downstream of the metering assembly.

41. The device of claim 40, further comprising a regulator assembly fluidly coupled to and upstream of the metering assembly, and wherein the regulator assembly configured to be fluidly coupled to a fluid supply and regulate a flow of a fluid distributed from the fluid supply.

42. The device of claim 38, further comprising a regulator assembly fluidly coupled to and downstream of the valve assembly, and wherein the regulator assembly configured to be fluidly coupled to a fluid supply and regulate a flow of a fluid distributed from the fluid supply.

43. The device of claim 37, wherein the fluid is liquefied petroleum gas (LPG).

44. The device of claim 37, wherein the fluid is liquefied natural gas (LNG).

45. The device of claim 37, wherein the fluid is water.

46. The device of claim 37, wherein the fluid is purified water.

47. The device of claim 37, wherein the fluid is compressed natural gas (CNG).

48. The device of claim 37, wherein the fluid is gasoline.

49. The device of claim 37, wherein the fluid is diesel.

50. The device of claim 37, wherein the fluid is kerosene.

51. The device of claim 37, wherein the fluid is cooking oil.

52. The device of claim 37, wherein the apparatus is a cook stove.

53. The device of claim 37, wherein the apparatus is a refrigerator.

54. The device of claim 37, wherein the apparatus is a clothes dryer.

55. The device of claim 37, wherein the apparatus is a heater.

56. The device of claim 37, wherein the apparatus is a barbeque.

57. The device of a claim 37, wherein the apparatus is a water heater.

58. The device of claim 37, wherein the apparatus is an oven.

59. The device of claim 37, wherein the apparatus is an engine.

60. The device of claim 37, wherein the apparatus is a generator.

61. The device of claim 37, wherein the apparatus is a storage vessel.

62. The device of claim 37, wherein a position of the locking assembly is remotely controlled.
